(19) United States
(12) Patent Application Publication
(10) Pub. No.: US 2003/0190046 A1
(43) Pub. Date: Oct. 9, 2003

(54) Three party signing protocol providing non-linkability

(76) Inventors: Matthew Albert Kamerman, Katonah, NY (US); Stephen Michael Matyas, JR., Manassas, VA (US); Carol Anne McNab, Tenafly, NJ (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/272,063

(22) Filed: Oct. 17, 2002

Related U.S. Application Data
(60) Provisional application No. 60/369,761, filed on Apr. 5, 2002.

(51) Int. Cl. H04L 9/00

(52) U.S. Cl. 380/286; 713/176

(57) ABSTRACT

A three-party signing protocol uses a Trusted Third Party (denoted T) to simulate a two-party protocol in which a sender, designated party A, anonymously signs data intended for a particular receiver, designated party B, such that B can verify the signature on the data without learning A's true identity, and data and signatures received by different receivers cannot be cross-linked, aggregated, or associated with a single sender. In this three-party signing protocol, A has only one public/private signature key-pair. In the three-party signing protocol, T is permitted to “see” signatures generated by A, but B is not permitted to “see” signatures generated by A, unless they are randomized or encrypted, since doing so would permit A's generated signatures and signed data to be cross-linked. Thus, in the three-party signing protocol, T is used to “vouch to B on behalf of A” that signatures generated by A are valid.

### DESCRIPTION

### BACKGROUND OF THE INVENTION

1. Field of the Invention

This invention relates to electronic digital signatures using public key cryptography, and more particularly to a method for signing data that provides non-traceability of information to individual identity and non-linkability across the data signed by each individual. That is, the method protects the privacy of the signer and additionally prevents verifiers from colluding to aggregate and link together messages and data signed by a signer.

2. Background Description

Public key cryptography is based on the use of a public key algorithm. Public key cryptography was developed in the 1970s to solve problems associated with symmetric key cryptography, where the same secret key is used for encrypting and decrypting. Public key cryptography, public key algorithms and various aspects of public-key cryptographic systems are described in the literature, including R. L. Rivest et al., “A Method for Obtaining Digital Signatures and Public-Key Cryptosystems”, Communications of the ACM, vol. 21, pp. 120-126 (February 1978), M. E. Hellman, “The Mathematics of Public-Key Cryptography”, Scientific American, vol. 234, no. 8, pp. 146-152, 154-157 (August 1979), and B. Schneier, Applied Cryptography, 2nd edition, John Wiley & Sons, New York, 1996.

In a public key cryptographic system, two keys are used, one for enciphering and another for deciphering. Public key cryptographic systems are designed so that it is easy to generate a random pair of inverse keys PU for enciphering and PR for deciphering and it is easy to operate with PU and PR, but is computationally infeasible to compute PR from PU. Each user generates a pair of inverse transforms, PU and PR. Each user keeps his deciphering transformation PR secret, and makes the enciphering transformation PU public by placing it in a public directory. Anyone can now encrypt messages and send them to the user, but no one else can decipher messages intended for that user. It is possible, and often desirable, to encipher with PU and decipher with PR. For this reason, PU is usually called a public key and PR is usually called a private key. A corollary feature of public key cryptographic systems is the provision of a digital signature, which uniquely identifies the sender of a message. If user A wishes to send a signed message M to user B, he or she operates on it with his or her private key PR to produce the signed message S. PR is used as A's deciphering key when privacy is desired, but it is now used as his “enciphering” key. When user B receives the enciphered message S, he or she can recover the plaintext message M by operating on the ciphertext S with A's public key PU. By successfully decrypting A's message, the receiver B has conclusive proof it came from sender A.

Examples of public key cryptography are provided in the following U.S. patents: U.S. Pat. No. 4,218,582 to Hellman, et al. for “Public Key Cryptographic Apparatus and Method”, U.S. Pat. No. 4,200,770 to Hellman, et al. for “Cryptographic Apparatus and Method”, and U.S. Pat. No. 4,405,829 to Rivest, et al. for “Cryptographic Communications System and Method.”

A “digital signature” is an unforgeable data element, which asserts that the user associated with the digital signature (i.e., whose private key was used to create the digital signature) either is the party who created the digital signature on a message of his or her choosing, or liking, or if instead the user is not the party who actually created the digital signature, then it is assumed that the user at least agreed with the content of the message that was signed with his or her private key. Typically, a digital signature is created by first hashing the message or data to be signed, using a one-way hashing function, encrypting the resulting hash value with the user's private key, and then appending the encrypted hash value to the message or data. This procedure can be described in even greater detail, as follows: To authenticate the content and origin of a message, A uses a one-way hash function to generate a hash value. The hash value is a fixed length data element that uniquely represents the source message, or data. Since the hash function is one-way, nothing about the content of the source message can be inferred from the hash value, provided that the input message or data has sufficient entropy. For example, two hash values produced from two messages that differ by only one character would appear to be a completely random reordering of characters. A then signs the message by encrypting the hash value using A's private key. The signature is typically appended to the message itself. A then transmits the signed message to B. In order to authenticate the received message, B uses the same one-way hash function used by A to create a hash value from the received message. B then decrypts the encrypted hash value using A's public key. The assumption is made here that B has a trustworthy copy of A's public key. If the decrypted hash value matches the hash value created from the received message, then the received message must be identical to the message from which the decrypted hash value was originally derived. Moreover, the fact that the decrypted hash value was decrypted using A's public key ensures that the decrypted hash value was originally encrypted with A's private key. If the two hash values agree, then B is assured that the received message is the identical message signed by A.

A significant attribute of public key cryptography is that there is no need to share a secret key or to transmit a secret key from the keyholder to a proposed communication partner. However, it is necessary to establish credibility for who owns public and private keys. For instance, C might replace A's public key with its own public key and fool B into encrypting messages intended for A under C's public key. In that case, C could read intercepted messages intended for A. Similarly, if C could replace A's public key with its own public key, then C could fool B into believing that messages signed with C's private key were signed by A using A's private key, thus allowing C to masquerade as A. To prevent being fooled, B needs to be sure that A's public key is in fact paired with the private key owned by the real A. A Certification Authority (CA) solves this problem. CAs provide digital certificates, containing public keys, which are used to transmit the public keys in a secure, authenticated manner to participants in c-commerce transactions.

A certificate is an unforgeable digitally signed data element that binds a user's public key to the user's identity information and that advantageously, but not necessarily, conforms to the international standard X.509 version 3, “The Directory-Authentication Framework 1988”, promulgated by the International Telecommunications Union (ITU). Each certificate includes the following critical information needed in the signing and verification processes: a version number, a serial number, an identification of the Certification Authority (CA) that issued the certificate, identifications of the issuer's hash and digital signature algorithms, a validity period, a unique identification of the user who owns the certificate (called distinguished name), and the user's public key. Certificates are issued and digitally signed by a CA. In effect, a certificate securely identifies the owner of the public key contained in the certificate, and therefore indirectly the private key corresponding to that public key. The public key contained in a certificate can be a key used for encryption or signature verification. A certificate is sometimes called a CERT, and a CERT can therefore be either an encryption CERT or a signature-verification CERT(also called an authentication CERT).

In addition to the cryptographic techniques and digital certificates provided by CAs, security and authentication of transactions is also supported by an extensive body of protocol standards. It is necessary for A to format messages, signatures, hash values, etc., with protocols that can be recognized by B. Cryptography, digital certificates, protocols, and standards together make up what is termed the Public Key Infrastructure (PKI).

A user's signature-verification CERT is usually appended along with the digital signature to the data or message being signed, thus enabling a receiver to more easily perform signature verification. Alternatively, the receiver may already have the CERT or the receiver may retrieve the CERT from a directory archive.

A Public Key Infrastructure (PKI) is a hierarchy of CAs responsible for issuing certificates and certified cryptographic keys for digitally signing and encrypting information objects. Certificates and certification frameworks are described in Tom Austin, PKI a Wiley Tech Brief, John Wiley & Sons, Inc., New York, 2001.

A problem with a signing protocol making use of CERTs is that it does not automatically protect the privacy of the signer. In some environments, applications, or settings, it may be advantageous to employ electronic digital signatures, e.g., to obtain the property of non-repudiation, yet the user may also wish to remain anonymous. Moreover, once you have been reliably identified by your digital signature and corresponding certificate you have lost any hope of remaining anonymous or preventing merchants from cross-linking their records about you. In cyberspace, the most dangerous threat to your privacy is not a wiretapper, but the other party to your transaction. For example, a user may not want to disclose his or her true identity in all cases in order to conduct certain electronic transactions over the Internet, which may include the use of electronic digital signatures. But if the signer's name or identity is specified in the CERT and the CERT is given to a verifier (disclosed or made public), then the user's identity is automatically revealed to the verifier. Furthermore, a user desirous of preserving his or her anonymity, or privacy, might be prevented from using a signing protocol.

Thus, it would be a useful objective to design privacy-protecting electronic communication and transaction systems, which would include the design of a privacy-protecting signing protocol that would protect the anonymity of users and would also prevent other parties to electronic transactions from cross-linking records associated with each user.

U.S. Patent Application Publication No. US 202/0004900 A1 “Method for Secure Anonymous Communication”, by Baiju V. Patel, discloses a method of secure anonymous communication between a first party and a second party, which is accomplished by establishing an identity of the first party with a third party, obtaining an anonymous certificate (also referred to as a pseudonymous certificate, having a selected attribute by the first party from the third party, and presenting the anonymous certificate by the first party to the second party for verification to establish the anonymous communication. Under some circumstances, a user may desire to retain anonymity during secure communications over the Internet or an intranet. Instead of full certification, a user may want to have attributes associated with the user to be certified to another party without disclosure of the user's identity.

An anonymous certificate (AC) is a digital certificate, where the distinguished name field appears to be random. It may be computationally impractical to determine the identity of the holder of the certificate from the distinguished name. An AC may have one of at least two classes of distinguished names. The first class represents a random number, and the second class represents a globally unique identifier (ID). When a random number is used for the identity of the certificate holder, only the issuer, i.e., the certificate authority (CA), and the holder of the certificate know the mapping between the holder's identity and the anonymous certificate. The CA does not know when and how the AC will be used (or even if it is used at all). However, the CA encodes the appropriate fields of the AC so that when the AC is present, the receiver may verify the attributes associated with the certificate. If the receiver trusts the issuer of the certificate, then the receiver may verify the attributes associated with the holder of the certificate, without learning the identity of the certificate holder.

In many cases, it may be desirable for the distinguished name to be a unique ID associated with the user instead of a random number. For example, the ID may be generated as a cryptographic hash (e.g., using the MD5 or SHA-1 hashing algorithms) on one or more attributes of the user such as name, place of residence, telephone number, age, social security number, mother's maiden name, etc. This technique allows for the possibility that a third party may establish whether a certain entity used the anonymous certificate or not (e.g., law enforcement). At the same time, it may be very difficult for someone to randomly determine if any user used a particular AC. Anonymous identifiers and anonymous certificates shall hereinafter be referred to as pseudonymous identifiers and pseudonymous certificates, conforming to the description found in Brands (cited above).

Thus, with a pseudonymous CERT, the user's anonymity is preserved by replacing the user's true identity in the distinguished name field in the CERT with an assigned pseudonymous identity. The “linkage” between the user's true identity and the user's pseudonymous identity is kept secret, thus preventing a verifier who sees the user's pseudonymous identity from learning the user's true identity.

U.S. Pat. No. 5,245,656 to S. K. Loeb and Y. Yacobi, for “Security Method for Private Information Delivery and Filtering In Public Networks”, discloses a method for operating customized information services via a network comprising transmitting the identity U of an end-user station via the network to a name translator station. At the name translator station, the identity U of the end-user station is translated into a pseudonym U′. The pseudonym U′ is used to access a user profile stored at a filter station, so that there is no way to associate a user profile with the actual end-user identity U.

U.S. Patent Application Publication No. US 202/0004900 A1 and U.S. Pat. No. 5,245,656 do indeed disclose methods for achieving user anonymity. However, the pseudonymous ID employed in each solution method remains constant across possibly many sessions and/or applications, involving possibly many different third parties that receive or have access to the pseudonymous IDs. Thus, the pseudonymous certificate described in U.S. Patent Application Publication No. US 202/0004/900 A1 and the pseudonym U′ (i.e., pseudonymous ID) described in U.S. Pat. No. 5,245,656 do not conceal the “participation relationship” between sessions or applications that make use of these data values.

European Patent Application No. EP 1 136 927 A2 for “Anonymous Participation Authority Management System”, by K. M. Sako, discloses a system allowing a participating subsystem to participate anonymously in a plurality of sessions without the participant's name or participating relationship between sessions being revealed. The invention relates to electronic access, electronic bidding, electronic lottery, electronic voting, or the like. There are three entities or subsystems comprising the described system: (1) a participant subsystem, (2) a manager subsystem, and (3) a reception subsystem. First, the participant subsystem proves to the manager subsystem that it is authorized to participate anonymously with a recipient subsystem. In turn, the manager system signs the public key of the participant subsystem with its own (manager system's) private key to produce a blind signature. The public key with the signature of the manager subsystem affixed is called an anonymous certificate. Next, the participant subsystem signs a message (e.g., a voting content) with its own secret key and sends the signed message and the anonymous certificate to a verification subsystem. The verification subsystem confirms that the received anonymous certificate contains a public key with a valid signature of the manager subsystem affixed to it and that the signature of the received message is correctly verified using the public key in the validated anonymous certificate. The anonymous certificate can be used repeatedly by different recipient subsystems to verify signatures generated by a single participant subsystem. An advantageous property of Sako's method is that only a single registration is required by each participating subsystem, that is, it is not necessary to conduct a registration for every session. Thus, as said, a participating subsystem can sign many different messages using the same anonymous certificate. Another advantageous property is that with Sako's method a recipient subsystem can detect whether two or more signed messages have been received from a single participating subsystem. The ability to detect two signed messages from the same participating subsystem is particularly useful in electronic voting applications to protect against double voting. The method described in European Patent Application No. EP 1 136 927 A2 is more generally known as a group signature scheme.

A group signature scheme allows members of a group to sign messages on behalf of the group. Signatures can be verified with respect to a single group public key (i.e., one public key used by all members of the group), but the signatures do not reveal the identity of the signer. Furthermore, it is not possible to decide whether two signatures have been issued by the same group member. However, in the event of a later dispute, there exists a designated group manager who can “open signatures” and reveal the identity of the signer. The concept of group signatures was introduced by Chaum and van Heyst, who also proposed the first realizations. Later, improvements were presented by other researchers. However, these proposed solutions had the following undesirable properties: (1) the length of the group's public key and/or the size of a signature depends on the size of the group, which is problematic for large groups; and (2) to add new group members, it is necessary to modify at least the public key. A paper by J. Camenisch and M. Stadler “Efficient group signature schemes for large groups”, Proceedings of EUROCRYPT '97, describes a group signature scheme that overcomes these problems. The lengths of the public key and of the signatures are, as well as the computational effort for signing and verifying, independent of the number of group members. Furthermore, the public key remains unchanged if new members are added to the group, and the size of the group is concealed as well.

Whereas the group signature scheme of Sako, described in European Patent Application No. EP 1 136 927 A2, and the group signature scheme of J. Camenisch and M. Stadler, described in their paper “Efficient group signature schemes for large groups”, Proceedings of EUROCRYPT '97, each have the advantageous property that only one registration is required per user, thereby allowing the user to generate a plurality of signatures on a plurality of messages, which are then provided to one or more different receiving systems or users who verify these signatures, these methods have the disadvantageous property that the signature algorithms themselves are relatively new. As yet, there are no cryptographic standards based on these signature algorithms. On the other hand, the RSA signature algorithm has existed for several years; the cryptographic strength of the RSA signature algorithm has been widely studied and analyzed by experts in the field of cryptography; cryptographic standards such as American National Standard X9.31-1998 Digital Signatures Using Reversible Public Key Cryptography For the Financial Services Industry (rDSA), based on the RSA signature algorithm, have been adopted or undertaken in both national and international standards organizations; and the RSA signature algorithm has been widely implemented in cryptographic systems and applications and an RSA-based public key infrastructure for creating and distributing public key certificates and certificate revocation lists has been developed and deployed world-wide. In short, the RSA signature algorithm has received wide visibility, scrutiny, and customer acceptance in the marketplace. For these many reasons, it would be desirable to have and make use of an RSA-based signing protocol that would achieve many of the objectives of to existing group signature schemes. In particular, it would be desirable to provide anonymous certificates capable of concealing the user's “participation relationship” between sessions so that generated signatures would be anonymous and unlinkable, yet which could be implemented using the existing Public Key Infrastructure, including present pubic key certificates and certificate revocation lists.

However, there are two problems presented by using the existing PKI and RSA-based CERTs, including pseudonymous CERTs. Each pseudonymous CERT contains pseudonymous ID and a public key, both of which are constant values. If a pseudonymous CERT were shared with more than one receiving party, then either the pseudonymous ID or the public key in the CERT could be used to cross-link the signed data provided to two or more different receiving parties by a single user. Cross-linking records might lead to an exposure of the identity of the user. For example, the user might share limited demographic information with several different receiving parties, which by itself would not allow any receiving party to learn the user's true identity. However, it might be the case that if the demographic information could be cross-linked and aggregated together, then this would allow the user's true identity to be determined. Likewise, a user may wish to utilize certain applications available via the Internet, which in turn require the user to reveal or make available information related to or about the user (e.g., medical information, demographic information, financial information, personal likes and dislikes, preferences, interests). However, if the data associated with a single user can be collected and aggregated, then it may be possible to identify the user on the basis of sophistical analysis techniques, thereby undermining the privacy of the user. Therefore, it would be advantageous to provide a method whereby data about a user stored at different locations accessible via the Internet could not be collected and aggregated.

One solution would be for each user to employ a different CERT, containing a different pseudonymous ID and different public key, for each receiving party that the user intends to provide signed data to. Thus, if the user wished to sign data and send it to receiving party “i” is would access its “i-th” private signing key and sign the data with that private key, access the “i-th” pseudonymous CERT, and send the data, generated signature and “i-th” pseudonymous CERT to receiving party “i”. The receiving party would validate the pseudonymous CERT using the PKI and then verify the signature on the received data using the public key in the pseudonymous CERT. The pseudonymous CERT in the pseudonymous CERT could be used by the receiving party to establish that the user is in fact a user known to the receiving party and it could also be used to access or store data under that pseudonymous ID in a database maintained by the receiving party. For example, the user my wish to share medical information about himself or herself with a receiving party who maintains a medical file on the user, and who (we assume) could provide some medical-related service to the user. By signing information sent to the receiving party, the receiving party is assured that changes to records in its database are authorized by the user himself or herself, whereas the pseudonymous ID allows the user's true identity to remain hidden, and prevents the user's medical records to be cross-linked with other information about that user stored at some other receiving party. Of course, the proposed method would not prevent or deter the user from making his or her true identity known to the receiving party, if so desired.

One problem with the described method is that each user must have a different public verification key and different private signature key, and a different pseudonymous CERT for each such public verification key, containing a different pseudonymous ID, for each receiving party with which the user intends to communicate. This requirement basically re-creates an n-squared key management problem, for which public key cryptography was specifically designed to eliminate. In short, the method does not scale and it undermines the intent of public key cryptography. What is needed is a signing protocol that scales well and prevents cross-linking a user's signed data provided to different receiving parties. A different solution for providing a scalable signing protocol, in which the user has only one pseudonymous CERT and one public/private key pair for signing, would be to employ a three-party signing protocol in which the user signs messages sent to a trusted third party (TTP). The trusted third party verifies the signed messages with the user's anonymous CERT and, if valid, then re-signs the message using its private signature key. The TTP then sends the received message, the generated signature, and TTP's CERT to the intended receiving party. The receiving party validates the TTP's CERT and then validates the TTP's signature using the TTP's public verification key obtained in and obtained from the CERT. In this protocol, the TTP is used to “vouch” to the receiving party on behalf of the user that the user's signature on the received message was verified and correct. In this protocol, the receiving party does not “see” the user's anonymous CERT. The use of TTPs as a means to “vouch” on behalf of one party to some other party is, in fact, a commonly used technique in the design of certain protocols.

U.S. Patent Application Publication No. US 2001/0039535 A1 “Methods and Systems for Making Secure Electronic Payments”, by Y. S. Tsiounis and C. Doherty, provides methods and systems for securing payment over a network from a customer to a merchant. A trusted party component receives an instruction from the customer to pay the merchant, the instruction including confidential payment information of the customer. The trusted party component creates payment authentication information based on the confidential payment information. Based on the payment authentication, the trusted party component pays the merchant on behalf of the customer without the confidential payment information of the customer being disclosed to the merchant.

U.S. Pat. No. Re. 34,954 to Haber et al. and U.S. Pat. No. 5,001,752 to Fischer disclose methods for time stamping documents using a TTP called a time stamping authority. In this case, the document originator hashes the document and transmits the hash value to the time stamping authority. The time stamping authority appends the current date and time to the hash value to create a time stamp receipt and digitally signs the time stamp receipt with a private signature key. The time stamping authority's public verification key is distributed and available to anyone interested in validating a time stamp receipt created by the time stamping authority. The public verification key is typically stored in a public key certificate (CERT) signed by a Certification Authority so that anyone desiring to validate the time stamp receipt with the public key can have confidence in the authenticity of the key.

Whereas the TTP-based protocols described in U.S. Patent Application Publication No. US 2001/0039535 A1, U.S. Pat. No. Re. 34,954, U.S. Pat. No. 5,001,752, in addition to others described in the literature, make use of a TTP to “vouch” on behalf of one party to another party, or perform a service on behalf of one party who interacts or communicates with another party, these TTP-based protocols do not offer or provide a solution to the three-party signing protocol.

On the other hand, International Pub. No. WO 01/90968 A1 for “A System and Method for Establishing a Privacy Communication Path”, by S. J. Engberg, discloses a three-party signing protocol utilizing a TTP for producing anonymous signatures and provides a solution for privacy enabling communication. The three parties to a communication are a CLIENT, a COMPANY, and a trusted party, or trusted third party, denoted TP. Privacy is established using multiple non-linkable pseudonyms or virtual identities (VIDs) combined with inter-mediation of online and offline communication channels. A virtual identity (VID) is a pseudonym for an individual, created for a specific purpose. A VID has an associated identifier. This identifier is a combination of <COMPANY-identifier> and <COMPANY-unique identifier for CLIENT> since this will by definition not be linkable across COMPANIES. The COMPANY-identifier is a fixed value for each company. The “COMPANY-unique identifier for CLIENT” could be a customer number assigned by the company's Customer Relationship Management System (e.g., a randomly-generated value different for each CLIENT known to that COMPANY). In principle, a different VID exists for each tuple (COMPANY, CLIENT). In the disclosed method, the TP knows the true identity of each CLIENT, in case of fraud on the part of any CLIENT. The TP constructs the VIDs and assigns them to CLIENTs. In the three-party signing protocol, it is assumed that a CLIENT wishes to purchase a product or service from a COMPANY and as part of the transaction CLIENT sends COMPANY a signed agreement. Prior to signing agreements with a particular COMPANY, a CLIENT must first contact the TP in order to establish a new VID, i.e., a virtual identity for the CLIENT towards a specific COMPANY. It is assumed that the COMPANY and CLIENT are already known to TP. In this case, CLIENT contacts TP and indicates a COMPANY that he or she wishes to establish a VID towards. In response, TP creates a new VID and links this to COMPANY. In addition, TP creates a public and private key pair (Cl.Vir.Pu, Cl.Vir.Pr), where Cl.Vir.Pu denotes the client's virtual public key and Cl.Vir.Pr denotes the client's virtual private key. The public/private key pair (Cl.Vir.Pu, Cl.Vir.Pr) is called a virtual client ID. TP keeps the private key Cl.Vir.Pr, which is not revealed to anyone else. TP signs the combination of the public key of the virtual identity, Cl.Vir.Pu, and the public key of COMPANY, Co.Pu, assumed to be provided to TP in a trustworthy manner (e.g., in a CERT), and forwards Cl.Vir.Pu, Co.Pu, and Sign(Cl.Vir.Pu+Co.Pu, TP.Pr) to CLIENT. CLIENT, who has a trustworthy copy of TP's public key TP.Pu (e.g., in a CERT), verifies TP's signature, Sign(Cl.Vir.Pu+Co.Pu, TP.Pr), using TP.Pu. CLIENT then signs the same combination and returns the signature Sign(Cl.Vir.Pu+Co.Pu, Cl.Pr) to TP. TP, who has a trustworthy copy of CLIENT's public key Cl.Pu (e.g., in a CERT), verifies CLIENT's signature, Sign(Cl.Vir.Pu+Co.Pu, Cl.Pr), using Cl.Pu. TP signs the combination of the public key of the virtual identity, Cl.Vir.Pu, and the public key of COMPANY, Co.Pu, and forwards Cl.Vir.Pu, Co.Pu, and Sign(Cl.Vir.Pu+Co.Pu, TP.Pr) to COMPANY. COMPANY, who has a trustworthy copy of TP's public key TP.Pu (e.g., in a CERT), verifies TP's signature, Sign(Cl.Vir.Pu+Co.Pu, TP.Pr), using TP.Pu. COMPANY then generates a CLIENT Token Identifier and sends the CLIENT Token Identifier to TP. As part of the described protocol, CLIENT saves “COMPANY, Co.Pu, Cl.Vir.Pu”; COMPANY saves “CLIENT, Cl.Vir.Pu”; and TP saves “COMPANY, CLIENT, Cl.Pu, Cl.Vir.Pu, Cl.Vir.Pr, Sign (Cl.Vir.Pu+Co.Pu, Cl.Pr), CLIENT Token Identifier”. CLIENT can sign any message in a non-reputable way with his private signature key, Cl.Pr. TP cannot defraud the CLIENT because TP does not know Cl.Pr. Only TP can verify this signature using Cl.Pu, since only TP knows the link between Cl.Pr and DS.Pu. (DS.Pu is a certified copy of Cl.Pu, e.g., a CERT containing Cl.Pu, and, in this case, the CERT is provided to TP but not to COMPANY). When TP has in possession a message signed by Cl.Pr, TP can sign the same message using the private key of the virtual identity Cl.Vir.Pr, and forward the message and signature to COMPANY. It is assumed that CLIENT and COMPANY establish a symmetric encryption key SYMKEY between them before using the three-party signing protocol, in which case the message is encrypted with SYMKEY prior to being signed with Cl.Pr by CLIENT. Thus, TP does not see the contents of the message signed by CLIENT, or in turn the contents of the message he signs with the virtual identity (key) Cl.Vir.Pr.

The three-party signing protocol for generating “anonymous signatures” in International Pub. No. WO 01/90968 A1 can be described as follows:

1. COMPANY generates an agreement, which it encrypts with the symmetric key SYMKEY not known by TP. COMPANY signs the encrypted message and forwards the encrypted message to TP.

2. TP verifies the COMPANY signature and confirms this by signing the encrypted message and forwarding the encrypted message to the related CLIENT. TP does not know the encryption key SYMKEY so TP is not able to read the contents of the message.

3. CLIENT verifies TP's signature (confirming COMPANY signature) and, after checking the agreement, signs the encrypted message and returns the signed encrypted message to TP.

4. TP verifies CLIENT's signature and the originality of message towards the original message forwarded by COMPANY (i.e., it verifies that the encrypted message received from CLIENT is the same as the encrypted message received from COMPANY). TP now has an encrypted agreement signed by both COMPANY and CLIENT. The encrypted agreement signed by both parties is stored for safekeeping on behalf of both CLIENT and COMPANY (i.e., it is escrowed at TP). TP strips off CLIENT's signature and signs on behalf of CLIENT using the Private Part of the CLIENT VID (using private key Cl.Vir.Pr), and also signs on behalf of himself (using private key TP.Pr) thereby confirming the existence of a signed agreement in safe custody (i.e., escrowed at TP). The encrypted message and signatures are forwarded to COMPANY.

5. COMPANY verifies signatures of VID (using public key Cl.Vir.Pu) and of TP (using public key TP.Pu) confirming the existence of an agreement signed by CLIENT.

It is important to note that CLIENT signs the public key of the CLIENT VID for verification at time of creation. TP therefore has a traceable and non-reputable line of signatures between CLIENT and COMPANY. CLIENT is protected from fraud by TP because TP cannot get CLIENT signature on the agreement. TP will be responsible towards COMPANY if TP signs an agreement on behalf of CLIENT without having CLIENT's signature in place. TP is protected from fraud by CLIENT and COMPANY, in union (i.e., collusion), because CLIENT does not know the secret key of the CLIENT VID (i.e., Cl.Vir.Pr) and is not able to generate deliberate fake anonymous signatures which are only signed by the VID (i.e., Cl.Vir.Pr).

However, the method disclosed by Engberg in International Pub. No. WO01/90968 has several shortcomings. Engberg's method requires the generation and use of a different public/private key pair (Cl.Vir.Pu, Cl.Vir.Pr) for each CLIENT and COMPANY pair. For example, 10,000 CLIENTS communicating with 100 COMPANIES would require 1,000,000 different public/private key pairs. Potentially, the generation and management of such a large number of public/private key pairs could add significantly to the cost of operating the TP. For practical purposes, the method is exposed to the original n-squared key management problem that public key cryptography was designed to eliminate. Hence, with respect to keys, the method lacks scalability. On the other hand, there seems to be no way to avoid assigning different VIDs for each CLIENT and COMPANY pair. However, the creation and management of large numbers of IDs is a far more straightforward, manageable, less costly, and less demanding, than the creation and management of large numbers of public/private key pairs. In Engberg's method, it appears that the virtual public key Cl.Vir.Pu is used in some cases as a virtual identifier. A more practical solution would be to design the three-party signing protocol such that keys and identifiers are treated as separate and independent values (i.e., de-coupled). In this way, the virtual key pair (Cl.Vir.Pu, Cl.Vir.Pr) could changed without requiring VID to be changed. In fact, one would expect keys to be changed periodically as a good security practice, thus allowing VIDs either to remain constant, or to be changed on a different schedule, for possibly different reasons. In short, the “rules” for good key management are not the same as the “rules” for good virtual identity management. Hence, de-coupling keys from virtual identifiers would be the most preferred design principle to be followed. In Engberg's method, TP escrows a copy of the encrypted message and copies of the signatures generated on the message by CLIENT and COMPANY. This escrowed information is needed by TP in case a dispute later arises between CLIENT and COMPANY. Suppose that COMPANY proves to an impartial party, using public key Cl.Vir.Pu, that it holds a valid signature generated on an encrypted message by TP. In this case, the burden then falls to TP to prove to the impartial party, using Cl.Pu (i.e., the public key of CLIENT), that it holds a valid signature generated on the same encrypted message by CLIENT. To do this, it is necessary for CLIENT's signature on the encrypted message to be escrowed, and later made available to TP. In Engberg's method, as said previously, TP escrows a copy of the encrypted message and CLIENT's signature in the event of a dispute. However, requiring TP to perform this escrow function again adds to the cost of operating TP. It would seem more natural for COMPANY to perform this escrowing function, since COMPANY is the party who decides whether to escrow a copy of the encrypted message and a copy of TP's signature generated with private key Cl.Vir.Pr. Each different COMPANY may have a different rule for escrowing messages and signatures, which may depend on the nature of the transaction between CLIENT and COMPANY, the amount of the transaction (e.g., if there is a payment made by CLIENT to COMPANY), and the duration of escrow, which may vary from COMPANY to COMPANY, CLIENT to CLIENT, or transaction to transaction. If TP performs escrowing, then this could lead to an unwieldy coordination problem between COMPANY and TP, since TP would need to escrow for as long as COMPANY escrows, and it could discard escrowed information only after COMPANY discards escrowed information. On the other hand, if COMPANY is the one who escrows all information, then TP's information is discarded when COMPANY discards its information, and TP's information is saved whenever COMPANY's information is saved. In short, when COMPANY performs the entire escrow function, there is no artificial escrow coordination problem introduced between TP and COMPANY. However, solving the escrow problem is not straightforward, since COMPANY and CLIENT might collude to cheat TP by conveniently misplacing the escrowed copy of CLIENT's signature, or COMPANY may unintentionally misplace the signature. In either case, without a copy of CLIENT's signature, TP would be unable to prove to an impartial party that CLIENT actually signed the message, in which case, TP would be left “holding the bag”, so-to-speak. Another problem with COMPANY performing the total escrow function is that COMPANY would “see” CLIENT's signature. In this case, two colluding COMPANIES could ask CLIENTs to sign the same agreed upon data. By comparing the generated signatures, the colluding COMPANIES could easily correlate or cross-link the signed data provided by the CLIENT to each of these colluding COMPANIES (including the different keys Cl.Vir.Pu shared with each COMPANY). This would defeat the intended security of the three-party signing protocol. One solution to this problem would be to employ randomized signatures, i.e., where the signature algorithm produces different signatures, even when the private signature generation key and the data to be signed are the same. The Digital Signature Algorithm (DSA) is an example of a signature algorithm that produces randomized signatures. On the other hand, the RSA signature algorithm does not produce randomized signatures. Thus, if one wanted to sign using the RSA signature algorithm, then other means would need to be employed to force the generation of randomized signatures. The reader will appreciate that finding a secure solution to the COMPANY escrow problem (i.e., permitting COMPANY to perform the entire escrowing function) would be extremely useful to the design of a three-party signing protocol, for the several reasons outlined above.

In a three-party signing protocol, suppose the three parties are denoted A, B, and T, where A is the signer (or sender), B is the verifier (or receiver), and T is the trusted third party. What is needed then is a three-party signing protocol that (1) can be implemented with the RSA signature algorithm, thus capable of achieving the several benefits and advantages outlined above, (2) does not require a separate public/private key pair for each sender-receiver, (3) de-couples key management from virtual identity management, (4) permits the message and signature escrow function to be securely performed by the receiver, (5) offloads as much of the three-party signing protocol functions from the T as possible, thus allowing the T to be implemented with minimal cost, and (6) achieves all other benefits and advantages outlined previously.

### SUMMARY OF THE INVENTION

It is therefore an object of the present invention to provide an electronic digital signature using public key cryptography.

It is another object of the invention to provide a method of signing information that protects the privacy of the signer and prevents verifiers from colluding to cross-link information signed by the signer.

According to the invention, there is provided a three-party signing protocol in which a Trusted Third Party (denoted T) is used to simulate a two-party protocol in which a sender (or signer), designated party A, anonymously signs a data (e.g., a document, data file, or message) intended for a particular receiver (or verifier), designated party B, such that B can verify the signature on the data without learning A's true identity, and datas and signatures received by different receivers cannot be cross-linked, aggregated, or associated with a single sender. However, a true two-party signing protocol with these attributes, would require A to hold a different public/private signature key-pair for each receiver, which would be an onerous requirement. But, in the three-party signing protocol, A has only one public/private signature key-pair. In the three-party signing protocol, T is permitted to “see” signatures generated by A, but B is not permitted to “see” signatures generated by A, unless the signatures are randomized signatures, since “seeing” non-randomized signatures generated by A would permit A's generated signatures and signed data to be cross-linked. A randomized signature is one that appears to be randomly generated, even when the same data is repeatedly signed with the same key. A signature produced with the RSA signature generating algorithm is an example of a non-randomized signature. A signature produced with the Digital Signature Algorithm (DSA) is an example of a randomized signature. Thus, in the three-party signing protocol, T is used to “vouch to B on behalf of A” that signatures generated by A are valid. Basically, to accomplish this, A generates a signature S1 on a data D, or alternately on a representation of the data D or on a representation of at least the data D, and sends (D, S1) to T. The representation of data D might be, for example, the data D itself, a hash value computed on the data D, or an encryption of data D. T verifies (D, S1), and if the signature S1 on D is valid, then T generates a signature S2 on D, or alternately on a representation of the data D or on a representation of at least the data D, and sends (D, S2) to B. B verifies (D, S2). If the signature S2 on D is valid, then B is assured that A's signature generated on D was also valid, in which case B can trust that A did indeed sign D, even though B does not verify A's signature directly, or necessarily even “see” A's signature, although there would be no harm in permitting B to “see” A's signature provided that the signature is a randomized signature. Thus, in the three-party signing protocol, B would save a copy of (D, S2) in case a dispute arises in which B must later prove to an impartial party that A indeed signed D. Of course, in reality, B can only prove to an impartial party that T signed D, presumably on A's behalf, in which case T must also produce a copy of A's signature S1 on D in order to prove to the impartial party that A indeed did sign D, thereby authorizing T to sign D on A's behalf. Thus, in the three-party signing protocol it is necessary to escrow both signatures, S1 and S2, since in case of a dispute, B must prove that T signed D, and T must prove that A signed D. However, for many reasons outlined above, it would be more advantageous for B to escrow A's signature S1 than for T to escrow A's signature S1. But, to prevent A's signature from being exploited by B, for purposes of cross-linking data, messages, or signatures belonging to A, A's signature is rendered useless to B either by encrypting A's signature in a key that will allow only T to decrypt and recover it or by enforcing that A's signature is a randomized signature. Either approach will operate effectively to prevent B from misusing A's signature. As said, a randomized signature is one that appears to be a randomly generated value, even when the same data is repeatedly signed with the same key. For example, a randomized signature could be generated from an otherwise non-randomized signature by including a random pad as part of the information signed, or as part the information hashed with a one-way hash algorithm and then signed. The assumption is made that signature length cannot be used as a means to identify A, either in whole or in part, and that if necessary the protocol can require signatures to be the same length in order to guarantee that signature length provides no possible information for identifying a particular A. If encryption is used to mask A's signature, then S1 is encrypted under a key that will permit T to later decrypt and recover it, and thus the encrypted value of S1 can be escrowed by B. For example, S1 could be encrypted with a public encryption key belonging to T, in which case, T possesses the private decryption key that will enable T to decrypt S1, in case of a dispute. The encrypted value of S1 is sent to B together with (D, S2). Thus, instead of escrowing only (D, S2) at B, B escrows (D, encrypted S1, S2). On the other hand, if a randomized signature is employed, then S1 is sent to B together with (D, S2). And, instead of escrowing only (D, S2) at B, B escrows (D, S1, S2).

A possibly more convenient notation, which captures both possibilities in a single notation, would be to replace S1 with “representation of S1.” In this case, a representation of S1 is either S1 itself, if S1 is a randomized signature, or an encryption of S1, if S1 is a non-randomized signature. The reader will appreciate that the copy of S1 provided to B could be a representation of S1, although for sake of simplicity, this notation is not always consistently carried forward in the discussion, and other notational descriptions may be used as well.

To preclude possible protocol difficulties or abuses, wherein B inadvertently or purposely loses A's encrypted signature, thereby preventing T from proving to an impartial party that A signed a data in question, the protocol requires T to sign (D, S1), i.e., T signs both D and S1. By signing (D, S1) instead of just D, T is assured that B must make S1 available to an impartial party who is asked to verify S2, i.e., one cannot verify S2 without also making S1 available for verification.

In the description of the three-party signing protocol given above, A signs data D. In actuality, the three-party signing protocol can be generalized a bit more with respect to the information signed by A. It is possible to effect a workable three-party signing protocol, in which A signs a representation of the data D, where a representation of the data D can be any one of the following: D itself or a function of D, where the function of D could be a one-way hash value computed on D, or possibly an encryption of D. This notion can be generalized even further by saying that A signs a representation of at least the data D, which allows for the possibility that A may sign more than just the representation of the data D. This could be advantageous in situations where additional data is integrated into the signing protocol because of additional design objectives to be satisfied by the protocol. The requirement to be satisfied, in this case, is that the information signed by A must contain some value v that binds D to v. For example, v could be D itself, or it could be an encrypted value prepared by encrypting D with a key that will permit B to decrypt and recover D, or it could be a hash value computed on D. Consider the case where v is a hash value computed on D. Suppose further that either B knows D in advance, based on the protocol established between A and B, or else A sends a copy of D to B, e.g., by including it in the three-party signing protocol information flows (encrypted or unencrypted depending of the wishes of A and B). In this case, we may assume that B has or receives a copy of D, and it also receives signed information from T that includes within it the value v, originating from A. In this case, B would first verify T's signature, extract v from the signed information, compute a similar hash value on its copy of D, and compare the computed hash value with v. If the two values are equal, then B has indirect proof that A signed v, and by virtue of the terms and conditions of the protocol agreed to be the parties, A, B and T, in advance, that “a signature generated on v is equivalent to a signature generated on D”.

The three-party signing protocol consists of three steps, as follows:

(1) A prepares a value M1 and sends M1 to T,

(2) T validates M1, prepares value M2, and either sends M2 to A, who in turn sends M2 to B, or else T sends M2 directly to B, and

(3) B validates M2 and either accepts and escrows M2, if M2 is valid, or rejects and discards M2, if M2 is not valid.

The information conveyed in M1 and M2 can be described. M1 contains the following information:

1. Information identifying A to T, or permitting A's identity to be determined by T, or permitting an identifier for A to be determined by T. T needs this information in order to derive or determine the pseudonymous identifier by which B knows A. The information identifying A could be an identifier that does not protect A's true identity, or it could be an anonymous identifier preestablished with T.

2. Information identifying B to T, or permitting B's identity to be determined by T, or permitting an identifier for A to be determined by T. T needs this information in order to derive or determine the pseudonymous identifier by which B knows A.

3. Information specifying data D, i.e., a representation of at least the data D, as follows: (1) at least a copy of D itself, or (2) at least function of D, where the function of D could be a one-way hash value computed on D or an encryption of D.

4. A signature generated by A on at least a sub-portion of M1 containing at least the “information specifying data D”. The signature is generated using public key cryptography, e.g., using the RSA signature generation algorithm.

5. Information that binds A's signature to A, e.g., (1) by including a CERT containing A's public verification key and information identifying A, or (2) by including information identifying A within the sub-portion of M1 signed by A.

6. Optionally, information permitting T to verify that the received M1 is intended for him, e.g., by including an identifier for T. This may be required if there is more than one T. But, if there is only one T, then T's identity with respect to the three-party signing protocol is implied. Thus, there may be no need to carry this information in M1.

7. Optionally, information needed by T to verify A's signature, e.g., a CERT containing A's public verification key. T may already have a stored copy of A's CERT, in which case there is no need for A to provide this information to T. On the other hand, if T does not store this information, then it may be useful and expedient for A to provide this information to T, in M1.

M2 contains the following information:

1. Information identifying A to B, or permitting A's pseudonymous identity to be determined by B, or permitting a pseudonymous identifier for A to be determined by B. In the most general case, B needs this information in order to conduct e-business with A, e.g., to sell or provide a service or product to A.

2. A copy of the information specifying data D, i.e., a representation of at least the data D, that A provided to T in M1, as follows: (1) at least a copy of D itself, or (2) at least a function of D, where the function of D could be a one-way hash value computed on D or an encryption of D.

3. A representation of the signature S1 generated by A on at least a sub-portion of M1 containing at least the “information specifying data D” that A provided to T in M1, except that the representation of A's signature is rendered useless to B for purposes of cross-linking data, messages, or signatures belonging to A either by encrypting A's signature in a key that will allow only T to decrypt and recover it or by causing A's signature to be a randomized signature, so as to ensure that the signature appears to be a randomly generated value, even when the same data is repeatedly signed with the same key.

4. A signature generated by T on at least a sub-portion of M2 containing at least (a) a copy of the information specifying data D, i.e., a representation of at least the data D, that A provided to T in M1 and (b) a representation of the signature S1 generated by A on at least a sub-portion of M1 containing at least the “information specifying data D” that A provided to T in M1. Basically, T's signature is generated on at least the information specified in items 2 and 3 of the present list.

5. Optional information identifying T to B, or permitting T's identity to be determined by B, or permitting an identifier for to bc determined by B. This may be required if there is more than one T. The protocol works as follows: A constructs an M1 that minimally identifies A to T, identifies B to T, contains a representation of at least data D, contains a signature S1 generated on a representation of at least the data D, and possibly on the information identifying A and B, and sends M1 to T.

Upon receipt of M1, T identifies A and B, confirms its known relationship with A and B, verifies A's signature, and if the signature is valid, then constructs an M2 that minimally identifies A to B which requires T to derive or determine A's pseudonymous identifier from the identifying information for A and B contained in M1, contains a representation of at least the data D (i.e., a copy of the information in M1 sent from A to T), contains a representation of A's signature (i.e., a copy of A's randomized signature or else a copy of A's non-randomized signature encrypted under a key that will permit T to later decrypt and recover it, but that will prevent B from decrypting and “seeing” it), and contains a signature generated by T on at least the same information that A generated its signature on, as well as on A's signature itself, and sends the so-produced M2 to B.

We assume that T has a copy of A's CERT containing A's public verification key, or that A sends the CERT to T together with or in M1. Likewise, we assume that B has a copy of T's CERT containing T's public verification key, or that T sends the CERT to B together with or in M2.

Upon receipt of M2, B validates T's signature, it confirms its relationship with A, known to B via A's pseudonymous identity or identifier contained in, or derived or determined from information in M2, confirms that the representation of at least the data D in M2 is agreeable to B, or is identical to a copy of D already stored at B, or the representation of at least the data D contained in M2 is equal in value to a like representation of at least the data D generated from a copy of D received or stored at B. If the signature is valid, and all other tests and checks performed on the received M2 by B are satisfactory to B, then B accepts M2 and minimally escrows (1) the sub-portion of M1 signed by A, and the sub-portion of M2 signed by T, (2) a copy of A's randomized or encrypted signature (i.e., the received representation of signature S1), and (3) a copy of T's signature. In practice, B would probably escrow all of M2, and additionally a copy of D if M2 contains only a function of D that does not permit B to directly recover D from that function of D, and any other information that B may need to verify T's signature. Basically, B must escrow all the information that an impartial party would need to verify T's signature. But, T needs to be certain that B will also escrow all the information that an impartial party would need to verify A's signature. As previously stated, the method for forcing B to save and later give up or produce this information on behalf of T is for T's signature to be generated on A's signature as well as on D (i.e., on a representation of at least the data D). In the event of a dispute, B provides its escrowed information to an impartial party. The impartial party first verifies T's signature on the appropriate sub-portion of the escrowed information, which includes A's signature as well as the appropriate sub-portion of the escrowed information on which A's signature is generated. If T's signature is valid, then B is upheld; otherwise B is not upheld. If T's signature is valid, then the impartial party next verifies A's signature on the appropriate sub-portion of the escrowed information that A's signature is generated on. If A's signature is valid, then T is upheld (meaning that A did sign the D in question); otherwise if A's signature is not valid, then A is upheld (meaning that A's claim of not signing the D in question is upheld).

In order for the three-party signing protocol to operate effectively, the parties A, B and T, must agree to the protocol, and the parties must be known to each other. This, in turn, implies that certain identifiers must be created and assigned, either in advance, or at the time the parties first use the protocol. The protocol must also permit identifiers to be changed periodically, as part of good ID management. Basically, T needs an identifier that “A and B know T by”, A needs an identifier that “T knows A by” and an identifier that “B knows A by”. We assume minimally that the identifier that “B knows A by” is a pseudonymous identifier, since only then are we assured that receivers cannot cross-link signatures and data signed by A. Further, we assume that T has a means to determine the identifier that “B know A by” from a combination of the identifier that “T knows A by” and the identifier that “T knows B by”. In addition, we assume an underlying public key infrastructure (PKI) is in place, supporting public and private keys, and CERTs, which are needed to implement the RSA signature algorithm. Likewise, we assume that the necessary public and private signature and encryption keys are generated and distributed to the parties in advance of using the three-party signing protocol. We assume minimally that A and T have a means to generate RSA signatures using an RSA signature generation algorithm and that T and B have a means to verify RSA signatures using an RSA signature verification algorithm.

Basically, the three-party signing protocol includes:

(1) a procedure for creating and transmitting protocol information, which includes the generation and verification of digital signatures;

(2) a procedure for escrowing protocol information; and

(3) a procedure for resolving disputes.

These three procedures work together to effect a workable three-party signing protocol that prevents signatures and data signed by a sender from being cross-linked.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of the components in the three-party signing protocol in accordance with an embodiment of the present invention;

FIG. 2 is a data flow diagram showing the three-party signing protocol according to a first embodiment of the invention;

FIG. 3 is a data flow diagram showing the three-party signing protocol according to a second embodiment of the invention;

FIG. 4 is a flow diagram illustrating the protocol steps associated with the data flows of FIG. 2;

FIG. 5 is a flow diagram illustrating the protocol steps associated with the data flows of FIG. 3; and

FIG. 6 is a flow diagram illustrating the steps in the dispute resolution protocol according to the invention.

### DETAILED DESCRIPTION OF PREFERRED EMBODIMENTS OF THE INVENTION

The following description is presented to enable any person of ordinary skill in the art to make and use the present invention. Various modifications to the preferred embodiment will be readily apparent to those of ordinary skill in the art, and the disclosure set forth herein may be applicable to other embodiments and applications without departing from the spirit and scope of the present invention and the claims hereto appended. Thus, the present invention is not intended to be limited to the embodiments described, but is to be accorded the broadest scope consistent with the disclosure set forth herein.

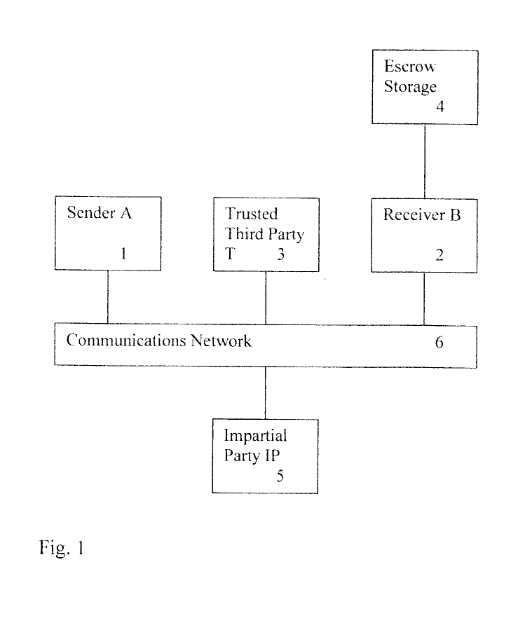

Referring now to the drawings, and more particularly to FIG. 1, there is shown a block diagram depicting the components of a three-party signing protocol, in accordance with the embodiments of the present invention, consisting of a sender A 1, a receiver B 2, a Trusted Third Party T 3, an escrow storage 4, and an impartial party 5. The sender A 1 signs data D (or representation or function of D) intended for the receiver B 2. In the three-party signing protocol, the receiver B 2 does not have the means to directly verify signatures generated by sender A 1. The trusted third party T 3 verifies signatures generated by sender A 1, and in turn “vouches” to B that A's signatures are valid by signing on A's behalf. An escrow storage 4 is utilized by the receiver B 2 to store received and validated three-party protocol information, or appropriate sub-portions thereof, thereby ensuring that receiver B 2 has a means for resolving disputes, should such a dispute later arise. To that end, an impartial party 5 is utilized by the sender A 1, the receiver B 2, and the trusted third party T 3 to resolve disputes, in accordance with a prescribed procedure for resolving disputes under the three-party signing protocol. The sender A 1, the receiver B 2, the trusted third party T 3, and the impartial party 5 communicate via a communications network 6, which may be proprietary network or a public network such as the Internet. The escrow storage 4 utilized by the receiver B 2 may be a local storage on a computer system belonging to the receiver B 2, or it could be a storage owned by an independent escrowing agent who offers an escrow service utilized by the receiver B 2. Thus, the escrow storage may be a local storage, as shown in FIG. 1, or it may be a remote storage accessible via a communications network such as the Internet (not shown in FIG. 1).

The three-party signing protocol makes use of the following cryptographic and protocol-related variables:

| | |
|---|---|
| A: | The identifier of sender A that “trusted third party T knows |
| | A by”. |
| A1: | The identifier of sender A that “receiver B knows A by”. |
| | Note that A would have a different identifier A2, A3, etc. |
| | for each additional receiver C, D, etc. with whom A |
| | interacts. |
| B: | The identifier of receiver B that “both A and T know B by”. |
| T: | The identifier of the trusted third party T that “both A and |
| | B know T by”. |
| D: | The data to be signed. |
| RN: | A random or pseudorandom number. |
| H: | A cryptographic one-way hash function, such as the Secure |
| | Hash Algorithm-1 (SHA-1). |
| H(X): | A hash value computed on datum X. |
| puX, prX: | A public/private pair of keys for encryption, belonging to |
| | entity X. |
| puX(Y): | A ciphertext produced by encryption of datum Y with public |
| | key puX. |
| suX, srX: | A public/private pair of keys for signing, belonging to entity |
| | X. |
| sigX(Y): | A digital signature generated on datum Y with the private |
| | signing key srX, belonging to entity X. |
| Cert-puX: | A certificate or certificate chain containing a public |
| | encryption key puX, belonging to entity X. |
| Cert-suX: | A certificate or certificate chain containing a public |
| | verification key suX, belonging to entity X. |

It is assumed that individual certificates can be made fixed length, if necessary, so that the length of encrypted certificates does not reveal any information contained in these certificates (e.g., the identity of the certificate holder). For example, this could be accomplished by requiring the certificates to be padded out to a prescribed length, sufficiently long enough to accommodate any certificate used in the protocol, prior to encypting the certificate.

Note that Cert-puX or Cert-suX may be a single certificate or “certificate chain” comprised of a chain of several linked certificates. The first certificate in the chain is validated using a trusted public key belonging to a Certification Authority (CA), the second certificate in the chain is validated using the public key contained in the first certificate in the chain, the third certificate in the chain is validated using the public key contained in the second certificate in the chain, and so forth, until all certificates in the chain have been validated. Note also that when a certificate chain is utilized, we assume that each certificate in the chain is separately encrypted via the encryption method described above, or the entire chain of certificates is encrypted after appropriate padding has been added to prevent the length of the chain from revealing information in any of the certificates in the chain.

In the three-party signing protocol, the assumption is made that the sender A has data D that it wishes to sign and send to the receiver B. The assumption is made that A has a public and private key pair (suA, srA) used for signing and B has a public and private key pair (puB, prB) used for encryption. A's signature verification key suA is distributed in certificate Cert-suA. B's public encryption key puB is distributed in certificate Cert-puB. An additional assumption is made that T has a public and private key pair (suT, srT) used for signing and a public and private key pair (puT, prT) used for encryption. T's signature verification key suT is distributed in certificate Cert-suT and its public encryption key puT is distributed in certificate Cert-puT.

The three-party signing protocol could also be effected from B to A, which would require A to have an additional public/private key pair for encryption and would require B to have an additional public/private key pair for signing. This additional level of complexity is not shown in the embodiments described herein.

FIG. 2 is a data flow diagram depicting the three-party signing protocol according to a first embodiment of the invention, in which (1) the sender A 1 creates a M1, which it sends to trusted third party T 3 at step 101, (2) the trusted third party T 3 validates M1, creates M2, which it sends to the sender A 1 at step 103, (3) the sender A 1 validates M2, creates B's_values, and sends M2 and B's_values to the receiver B 2 at step 105, and (4) the receiver B 2 validates M2 using B's_values, and then escrows M2 and B's_values.

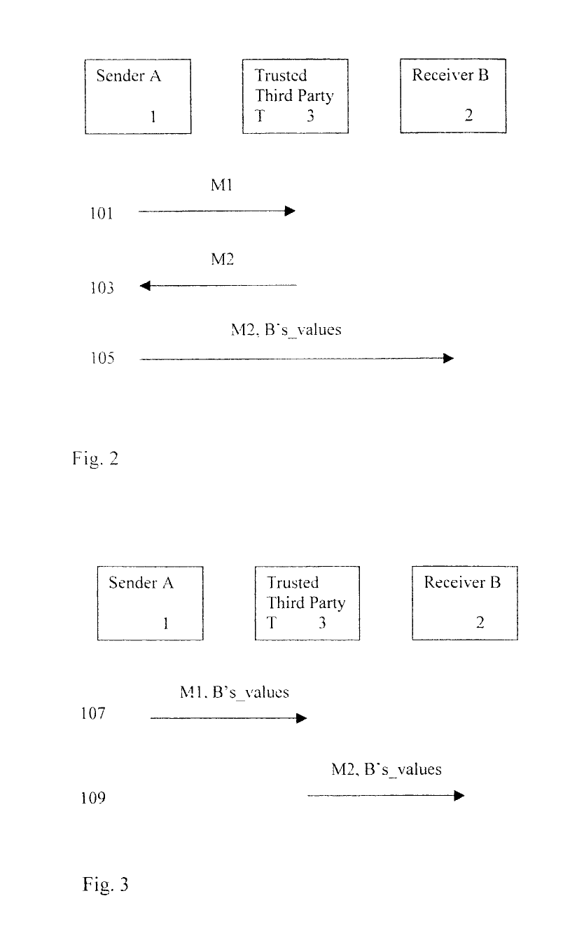

FIG. 3 is a data flow diagram diagram depicting the protocol flows of the three-party signing protocol a second embodiment of invention, in which (1) the sender A 1 creates M1 and B's_values, which it sends to trusted third party T 3 at step 107, (2) the trusted third party T 3 validates M1, creates M2, and sends M2 and B's_values to the receiver B 2 at step 109, and (3) the receiver B 2 validates M2 using B's_values, and then escrows M2 and B's_values.

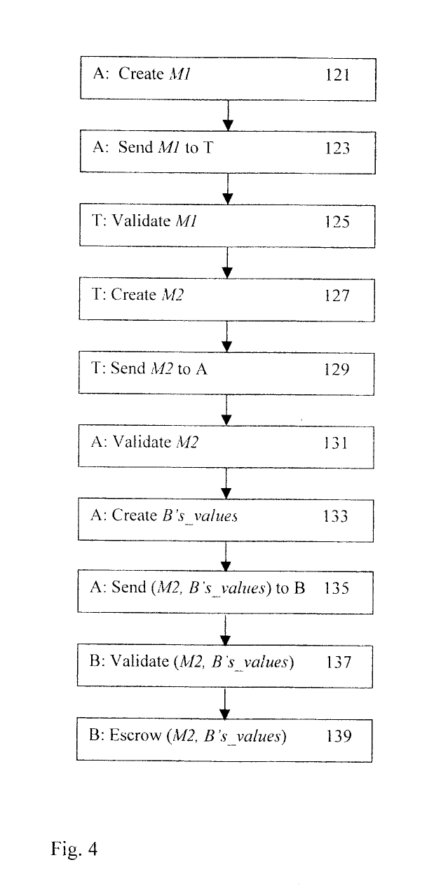

FIG. 4 is a flowchart of protocol steps associated with the three-party signing protocol flows depicted in FIG. 2, in accordance with the first embodiment of the invention. The three-party signing protocol assumes that the sender A has copies of the following certificates prior to execution of the protocol: Cert-suA, Cert-puT, and Cert-puB. However, the reader will appreciate that other variations are possible. For example, A needs Cert-suA only because within the protocol it sends a copy of Cert-suA to T. However, if T already has a copy of this certificate, then there would be no need for A to send T this certificate and, hence, there would be no need for A to have a copy of Cert-suA prior to execution of the protocol. In addition, A might acquire one or more of these certificates within the protocol itself, either by requesting the certificate or certificates from another party or by being provided the certificate or certificates automatically by another party or by other parties.

Sender A creates M1 at step 121 by performing the following steps: A random number RN is generated. The intermediate value (D,RN) is formed by concatenating D and RN, where D is the data to be signed. A hash value H(D,RN) is computed on (D,RN) using a cryptographic hash function H, e.g., using the Secure Hash Algorithm-1 (SHA-1). Alternatively, RN could be used as a secret key with the HMAC function to compute the hash value H(D,RN). Next, a symmetric encryption key K1 is generated, where K1 is a strong key (e.g., K1 is a 128-bit encryption key). Next, Cert-suA is encrypted with K1 using a symmetric encryption algorithm such as the triple DES or the Advanced Encryption Standard (AES) to produce the ciphertext K1(Cert-suA). Then, A1 is encrypted with K1 using a symmetric encryption algorithm such as the triple DES or AES to produce K1(A1), where A1 is the identifier that “T knows A by”. Next, Cert-puT is validated using the PKI. Note that Cert-puT may be a “certificate chain” composed of several linked certificates, in which case the entire chain of certificates is validated using the PKI. Then, K1 is encrypted with T's public encryption key puT obtained from Cert-puT to produce puT(K1). (For example, the public key encryption operation could be accomplished using a public key encryption primitive described in IEEE P1363 Standard Specifications for Public Key Cryptography, Section 11 Encryption Schemes, Section 12.2 Message Encoding Methods for Encryption, and Section 14 Auxiliary Functions.) Next, the intermediate value Q1={A1, T, B, H(D,RN)} is formed by concatenating the identifiers A1, T, and B, with the hash value H(D,RN). Then, Q1 is signed with A's private signing key srA to produce signature sigA(Q1). Next, the value M1={K1(A1), T, B, H(D,RN), sigA(Q1), puT(K1), K1(Cert-suA)} is formed by concatenating together: A's encrypted identifier K1(A1), T's identifier T, B's identifier B, hash value H(D,RN), A's signature generated on Q1, sigA(Q1), the encrypted key puT(K1), and the encrypted certificate K1(Cert-suA). Sender A stores and saves the values RN and M1, since these values are used later in the protocol.

Sender A sends M1 to trusted third party T in step 123. The reader will appreciate that, in the above steps, Cert-suA and A1 are encrypted under a key, K1, which only T is able to recover. This prevents the receiver B from “seeing” Cert-suA or A1, since the protocol requires B to escrow these values to ensure they will be available to T in the event of a dispute.

Trusted third party T validates M1 in step 125 by performing the following steps: The received M1 is parsed to obtain K1(A1), T, B, H(D,RN), sigA(Q1), puT(K1), and K1(Cert-suA). puT(K1) is decrypted with T's private decryption key prT to recover K1; K1(Cert-suA) is decrypted with K1 to recover Cert-suA; and K1(A1) is decrypted with K1 to recover A1. Next, the intermediate value Q1={A1, T, B, H(D,RN)} is formed by concatenating the identifiers A1, T, and B, with the hash value H(D,RN). The association between A1 and Cert-suA is examined to verify that Cert-suA is in fact a certificate associated with identifier A1. Cert-suA is validated using the PKI (note that Cert-suA may be a “certificate chain” composed of several linked certificates, in which case the entire chain of certificates is validated using the PKI). The signature sigA(Q1) generated on Q1 is verified against the formed value of Q1 using A's signature verification key suA obtained from Cert-suA.

Trusted third party T creates M2 in step 127 by performing the following steps: The identifiers A1 and B are used to determine identifier A1, e.g., by computing A2 from A1 and B, or using A1 and B to index the value A2. The reader will appreciate that there are many possible ways in which a third value, A2, can be determined from two input values, A1 and B, and that the present invention does not specify a particular method in which A2 must be determined from A1 and B. Next, individual hash values are computed on A2, K1(A1), T, B, H(D,RN), sigA(Q1), puT(K1) and K1(Cert-suA) to produce H(A2), H(K1(A1)), H(T), H(B), H(H(D,RN)), H(sigA(Q1)), H(puT(K1)), and H(K1(Cert-suA)). For convenience, these computed hash values are denoted H1, H2, . . . , H8. The intermediate value Q2={A2, M1, H1, . . . , H8} is next formed by concatenating A2, M1, and hash values H1 through H8. Note that the protocol could be extended to optionally encrypt A2 under a key known only to B, if this extra level of protection would be desired. Then, Q2 is signed with T's private signing key srT to produce signature sigT(Q2). Next, the value M2={A2, M1, sigT(Q2), Cert-suT} is formed by concatenating together: A's identifier A2, the received value M1, T's signature generated on Q2, sigT(Q2), and the certificate Cert-suT.

The reader will appreciate that the computation and use of the eight hash values H1, H2, . . . , H8, in Q2, ensures that B, who receives Q2, cannot demonstrate the validity of T's signatures on Q2 without also revealing the correct eight values A2, K1(A1), T, B, H(D,RN), sigA(Q1), puT(K1), and K1(Cert-suA). This ensures that these eight values will be individually available to an impartial party charged with verifying A's signature on Q1, in the event of a dispute. The potential danger averted by this design is this: If Z is an n-bit value resulting from the concatenation of values X and Y, one observes that there are several ways in which Z could be separated into two values such that their concatenation would again produce Z. For example, X could be represented by the first bit of Z and Y by the remaining n−1 bits, or X could be represented by the first two bits of Z and Y by the remaining n−2 bits, and so forth. But if Z is thc concatenation of X, Y, H(X), and H(Y), then for practical purposes, there is only one way to separate Z into pieces such that H(X) is computed from X and H(Y) is computed from Y. In effect, by including the eight hash values in the computed signature, B is forced to retain and reveal the correct eight individual values: A2, K1(A1), T, B, H(D,RN), sigA(Q1), puT(K1), and K1(Cert-suA), in order to validate T's signature.

Trusted third party T sends M2 to sender A 129, FIG. 4.

Sender A validates M2 in step 131 by performing the following steps: The received value M2 is parsed to obtain A2, M1, sigT(Q2), and Cert-suT. The value of M1 received in M2 is verified to be equal to the value of M1 previously sent to T (note that A saves a copy of M1 for this purpose). Optionally, the correctness of A2 is verified. Note that A may have a capability to independently determine A2 from A1 and B, thus giving A the capability to independently verify that the value of A2 received in M2 is correct. Cert-suT is validated using the PKI. Note that Cert-suT may be a “certificate chain” composed of several linked certificates, in which case the entire chain of certificates is validated using the PKI. Next, individual hash values are computed on A2, K1(A1), T, B, H(D,RN), sigA(Q1), puT(K1) and K1(Cert-suA) to produce H(A2), H(K1(A1)), H(T), H(B), H(H(D,RN)), H(sigA(Q1)), H(puT(K1)), and H(K1(Cert-suA)). For convenience, these computed hash values are denoted H1, H2, . . . , H8. The intermediate value Q2=A2, M1, H1, . . . , H8 is next formed by concatenating A2, M1, and hash values H1 through H8 and the signature sigT(Q2) generated on Q2 is verified against the formed value of Q2 using T's signature verification key suT obtained from Cert-su T.

Sender A creates B's_values in step 133 by performing the following steps: A symmetric encryption key K2 is generated, where K2 is a strong key (e.g., K2 is a 128-bit encryption key). The data D is encrypted with K2 using a symmetric encryption algorithm such as the triple DES or the AES to produce K2(D), and the retained copy of RN (produced previously in the protocol) is encrypted with K2 using a symmetric encryption algorithm such as the triple DES or the AES to produce K2(RN). Next Cert-puB is validated using the PKI. Note that Cert-puB may be a “certificate chain”. Then, K2 is encrypted with B's public encryption key puB obtained from Cert-puB to produce puB(K2). Next, B's_values={puB(K2), K2(D), K2(RN)} is formed by concatenating the generated values of puB(K2), K2(D), and K2(RN). Note that D and RN are encrypted under a key known only to B to prevent T and others from “seeing” these values.

Sender A sends M2 and B's_values to receiver B in step 135. The receiver B then validates the received value M2 using the received B's_values in step 137 by performing the following steps: B's_values is parsed to obtain puB(K2), K2(D) and K2(RN); M2 is parsed to obtain A2, M1, sigT(Q2), and Cert-suT; M1 is parsed to obtain K1(A1), T, B, H(D,RN), sigA(Q1), puT(K1), and K1(Cert-suA). Note that although B “sees” A's signature sigA(Q1), this does no harm, as sigA(Q1) is a randomized signature due to the random number RN concatenated with D before hashing and signing with A's private signature generation key srA. Consistency checking is performed on A2, e.g., by verifying that A2 is the identifier of the expected sender, or that A2 is at least an identifier of a sender known to the receiver. Next, the association between T and Cert-suT is verified, e.g., to ensure that Cert-suT is a certificate belonging to the anticipated trusted third party T, or that T is at least an identifier of a trusted third party known to the receiver. Next, the received value of B is verified to be this receiver's identifier. Next, Cert-suT is validated using the PKI. Note that Cert-suT may be a “certificate chain” composed of several linked certificates, in which case the entire chain of certificates is validated using the PKI. Individual hash values are computed on A2, K1(A1), T, B, H(D,RN), sigA(Q1), puT(K1), and K1(Cert-suA) to produce H(A2), H(K1(A1)), H(T), H(B), H(H(D,RN)), H(sigA(Q1)), H(puT(K1)), and H(K1(Cert-suA))}. Then, value Q2={A2, M1, H1, . . . , H8} is formed by concatenating A2, M1, and hash values H1 through H8, and the signature sigT(Q2) generated on the formed value Q2 is verified using T's signature verification key suT obtained from Cert-suT. Next, puB(K2) is decrypted using B's private decryption key prB; and K2(D) and K2(RN) are decrypted with the recovered value of K2 to obtain D and RN, respectively. Consistency checking is performed on D to ensure that it is acceptable. Next, the value (D,RN) is formed by concatenating the recovered values of D and RN, and the hash value H(D,RN) is computed on (D,RN) using the same one-way hash function used by sender A. Then, the computed hash value H(D,RN) is verified to be equal to the hash value H(D,RN) received in M2. If the hash values are equal, then {M2, B's_values} is accepted; otherwise, 1M2, B s_values) is rejected and discarded.

If {M2, B's_values} is accepted, then the receiver B stores {M2, B's_values}, or an appropriate sub-portion of {M2, B's_values}, in a data repository in step 139 so that it can be used later by B to settle a possible dispute, e.g., a dispute in which A denies having signed H(RN,D).

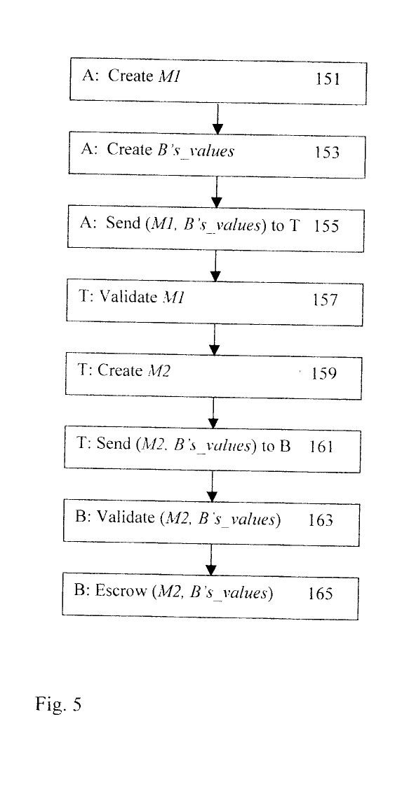

FIG. 5 is a flowchart of protocol steps associated with the three-party signing protocol flows depicted in FIG. 3, in accordance with a second embodiment of the invention. The three-party signing protocol assumes that the sender A has copies of the following certificates prior to execution of the protocol: Cert-suA, Cert-puT, and Cert-puB.

Sender A creates M1 in step 151 by performing the following steps: A random number RN is generated. The intermediate value (D,RN) is formed by concatenating D and RN, where D is the data to be signed. A hash value H(D,RN) is computed on (D,RN) using a cryptographic hash function H, e.g., using the Secure Hash Algorithm-1 (SHA-1). Alternatively, RN could be used as a secret key with the HMAC function to compute the hash value H(D,RN). Next, a symmetric encryption key K1 is generated, where K1 is a strong key (e.g., K1 is a 128-bit encryption key). Next, Cert-suA is encrypted with K1 using a symmetric encryption algorithm such as the triple DES or the Advanced Encryption Standard (AES) to produce the ciphertext K1(Cert-suA). Then, A1 is encrypted with K1 using a symmetric encryption algorithm such as the triple DES or AES to produce K1(A1), where A1 is the identifier that “T knows A by”. Next, Cert-puT is validated using the PKI. Note that Cert-puT may be a “certificate chain” composed of several linked certificates, in which case the entire chain of certificates is validated using the PKI. Then, K1 is encrypted with T's public encryption key puT obtained from Cert-puT to produce puT(K1). (For example, the public key encryption operation could be accomplished using a public key encryption primitive described in IEEE P1363 Standard Specifications for Public Key Cryptography, Section 1 Encryption Schemes, Section 12.2 Message Encoding Methods for Encryption, and Section 14 Auxiliary Functions.) Next, the intermediate value Q1={A1, T, B, H(D,RN)} is formed by concatenating the identifiers A1, T, and B, with the hash value H(D,RN). Then, Q1 is signed with A's private signing key srA to produce signature sigA(Q1). Next, the value M1={K1(A1), T, B, H(D,RN), sigA(Q1), puT(K1), K1(Cert-suA)} is formed by concatenating together: A's encrypted identifier K1(A1), T's identifier T, B's identifier B, hash value H(D,RN), A's signature generated on Q1, sigA(Q1), the encrypted key puT(K1), and the encrypted certificate K1(Cert-suA). Sender A stores and saves the values RN and M1, since these values are used later in the protocol.

Sender A next creates B's_values in step 153 by performing the following steps: A symmetric encryption key K2 is generated, where K2 is a strong key (e.g., K2 is a 128-bit encryption key). The data D is encrypted with K2 using a symmetric encryption algorithm such as the triple DES or the AES to produce K2(D), and the retained copy of RN (produced previously in the protocol) is encrypted with K2 using a symmetric encryption algorithm such as the triple DES or the AES to produce K2(RN). Next Cert-puB is validated using the PKI. Note that Cert-puB may be a certificate chain. Then, K2 is encrypted with B's public encryption key puB obtained from Cert-puB to produce puB(K2). Next, B's_values={puB(K2), K2(D), K2(RN)} is formed by concatenating the generated values of puB(K2), K2(D), and K2(RN). Note that D and RN are encrypted under a key known only to B to prevent T and others from “seeing” these values.

Sender A sends M1 and B's_values to trusted third party T in step 155. The reader will appreciate that, in the above steps, Cert-suA and A1 are encrypted under a key, K1, which only T is able to recover. This prevents the receiver B from “seeing” Cert-suA or A1, since the protocol requires B to escrow these values to ensure they will be available to T in the event of a dispute.

Trusted third party T validates M1 in step 157 by performing the following steps: The received M1 is parsed to obtain K1(A1), T, B, H(D,RN), sigA(Q1), puT(K1), and K1(Cert-suA). puT(K1) is decrypted with T's private decryption key prT to recover K1; K1(Cert-suA) is decrypted with K1 to recover Cert-suA; and K1(A1) is decrypted with K1 to recover A1. Next, the intermediate value Q1={A1, T, B, H(D,RN)} is formed by concatenating the identifiers A1, T, and B, with the hash value H(D,RN). The association between A1 and Cert-suA is examined to verify that Cert-suA is in fact a certificate associated with identifier A1. Cert-suA is validated using the PKI (note that Cert-suA may be a “certificate chain” composed of several linked certificates, in which case the entire chain of certificates is validated using the PKI). The signature sigA(Q1) generated on Q1 is verified against the formed value of Q1 using A's signature verification key suA obtained from Cert-suA.

Trusted third party T creates M2 in step 159 by performing the following steps: The identifiers A1 and B are used to determine identifier A1, e.g., by computing A2 from A1 and B, or using A1 and B to index the value A2. The reader will appreciate that there are many possible ways in which a third value, A2, can be determined from two input values, A1 and B, and that the present invention does not specify a particular method in which A2 must be determined from A1 and B. Next, individual hash values are computed on A2, K1(A1), T, B, H(D,RN), sigA(Q1), puT(K1) and K1(Cert-suA) to produce H(A2), H(K1(A1)), H(T), H(B), H(H(D,RN)), H(sigA(Q1)), H(puT(K1)), and H(K1(Cert-suA)). For convenience, these computed hash values are denoted H1, H2, . . . , H8. The intermediate value Q2={A2, M1, H1, . . . , H8} is next formed by concatenating A2, M1, and hash values H1 through H8. Note that the protocol could be extended to optionally encrypt A2 under a key known only to B, if this extra level of protection would be desired. Then, Q2 is signed with T's private signing key srT to produce signature sigT(Q2). Next, the value M2={A2, M1, sigT(Q2), Cert-suT} is formed by concatenating together: A's identifier A2, the received value M1, T's signature generated on Q2, sigT(Q2), and the certificate Cert-suT.

The reader will appreciate that the computation and use of the eight hash values H1, H2, . . . , H8, in Q2, ensures that B, who receives Q2, cannot demonstrate the validity of T's signatures on Q2 without also revealing the correct eight values A2, K1(A1), T, B, H(D,RN), sigA(Q1), puT(K1), and K1(Cert-suA). This ensures that these eight values will be individually available to an impartial party charged with verifying A's signature on Q1, in the event of a dispute. The potential danger averted by this design is this: If Z is an n-bit value resulting from the concatenation of values X and Y, one observes that there are several ways in which Z could be separated into two values such that their concatenation would again produce Z. For example, X could be represented by the first bit of Z and Y by the remaining n−1 bits, or X could be represented by the first two bits of Z and Y by the remaining n−2 bits, and so forth. But if Z is the concatenation of X, Y, H(X), and H(Y), then for practical purposes, there is only one way to separate Z into pieces such that H(X) is computed from X and H(Y) is computed from Y. In effect, by including the eight hash values in the computed signature, B is forced to retain and reveal the correct eight individual values: A2, K1(A1), T, B, H(D,RN), sigA(Q1), puT(K1), and K1(Cert-suA), in order to validate T's signature.

Trusted third party T sends M2 and B's_values to receiver B in step 161. The receiver B validates the received value M2 using the received B's_values in step 163 by performing the following steps: B's_values is parsed to obtain puB(K2), K2(D) and K2(RN); M2 is parsed to obtain A2, M1, sigT(Q2), and Cert-suT; M1 is parsed to obtain K1(A1), T, B, H(D,RN), sigA(Q1), puT(K1), and K1(Cert-suA). Note that although B “sees” A's signature sigA(Q1), this does no harm, as sigA(Q1) is a randomized signature due to the random number RN concatenated with D before hashing and signing with A's private signature generation key srA. Consistency checking is performed on A2, e.g., by verifying that A2 is the identifier of the expected sender, or that A2 is at least an identifier of a sender known to the receiver. Next, the association between T and Cert-suT is verified, e.g., to ensure that Cert-suT is a certificate belonging to the anticipated trusted third party T, or that T is at least an identifier of a trusted third party known to the receiver. Next, the received value of B is verified to be this receiver's identifier. Next, Cert-suT is validated using the PKI. Note that Cert-suT may be a “certificate chain” composed of several linked certificates, in which case the entire chain of certificates is validated using the PKI. Individual hash values are computed on A2, K1(A1), T, B, H(D,RN), sigA(Q1), puT(K1), and K1(Cert-suA) to produce H(A2), H(K1(A1)), H(7), H(B), H(H(D,RN)), H(sigA(Q1)), H(puT(K1)), and H(K1(Cert-suA))}. Then, value Q2={A2, M1, H1, . . . , H8} is formed by concatenating A2, M1, and hash values H1 through H8, and the signature sigT(Q2) generated on the formed value Q2 is verified using T's signature verification key suT obtained from Cert-su T. Next, puB(K2) is decrypted using B's private decryption key prB; and K2(D) and K2(RN) are decrypted with the recovered value of K2 to obtain D and RN, respectively. Consistency checking is performed on D to ensure that it is acceptable. Next, the value (D,RN) is formed by concatenating the recovered values of D and RN, and the hash value H(D,RN) is computed on (D,RN) using the same one-way hash function used by sender A. Then, the computed hash value H(D,RN) is verified to be equal to the hash value H(D,RN) received in M2. If the hash values are equal, then {M2, B's_values} is accepted; otherwise, {M2, B's_values} is rejected and discarded.

If the received quantity {M2, B's_values} is accepted, then the receiver B stores {M2, B's_values}, or an appropriate sub-portion of {M2, B's_values}, in a data repository in step 165 so that it can be used later by B to settle a possible dispute, e.g., a dispute in which A denies having signed H(RN,D).

The reader will appreciate that additional steps could be added to the described protocol to further enhance its viability or operability. For example, in the case where T forwards {M2, B's_values} to B, as in the second embodiment of the invention, T could also be required to return some “evidence” to A that its request has been acted upon and that T has indeed sent the quantity {M2, B's_values} to B. The reader will appreciate that a myriad of ways exist in which such a requirement might be satisfied, from simply (1) providing A with an acknowledgment message indicating that the value {M2, B's_values} has been sent to B to (2) providing A with some form of cryptographic receipt or proof that the value {M2, B's_values} has been sent to B, e.g., a signed, time-stamped receipt noting that the signed data has been forwarded to B, so that A has evidence of compliance in the signing process in case B later finds it convenient to deny that A signed the message. Note that this does not provide proof that B received the quantity {M2, B's_values}, but in cases where A is tasked to produce a signature, it would defend A, particularly if T includes a timestamp with its signature.

The reader will further appreciate that, in both embodiments of the described invention, identifier A2 could be a persistent value utilized by T or it could even be a single use random value created by A or T as part of the execution of the three-party signing protocol. This latter situation could be particularly useful when A is responding to a generic offer from B, e.g., a limited time offer B posts to an electronic bulletin board, since the process of tendering the signed offer back to B is sufficient for B's needs, e.g., as part of “blind” e-commerce through separate billing and shipping intermediaries.

The reader will further appreciate that both embodiments of the invention could be extended further so that B has an identifier B that “T knows B by” and a different identifier B1 that “A knows B by,” where in this case B1 is a pseudonymous identifier. This would broaden the invention to handle cases where A communicates with B entirely through T, or some pseudonomizing or anonymizing system such as www.anonymizer.net, a NYM2 remailer, or a blind drop box. For example, A might pick up a generic offer from B posted via a NYM2 pseudonym to a newsgroup, fill in the form, send it to T for counter-signing, and then return it to “B-sub-NYM2-for-newsgroup-foo”, all without ever knowing B's true identity. In fact, the identifier A that “T knows A by” and the identifier B that “T knows B by” could themselves be pseudonymous identifiers, such that T does not know the true identities of A and B. For example, the identifiers A and B could be assigned to A and B, respectively, by yet another trusted party T′, i.e., a party trusted by A, B and T. So long as a deterministic chain exists that will either (1) allow identification of A and/or B to the impartial party, or arbitrator, or (2) will permit the party who has assumed liability for A and/or B to be identified or located, then this extra level of anonymity or privacy protection can be effected. This means that A and/or B could be introduced to T by a foreign party that T trusts, under a reversible privacy protocol where the issuer or issuers of the pseudonyms, A and B, have a pre-established protocol for re-identification of A and B, e.g., under subpoena or determination of probable cause. Conversely, A and/or B could be known to T under an irreversible privacy protocol, e.g., using anonymous certificates bound to some quantity of digital cash (similar to being bonded), so long as the issuer of the anonymous certificate has defined the circumstances under which it can be held liable for the actions of its subscribers. Note that if the identities of A and B are not directly known to T, then T may need to receive prior support agreements from those parties or agencies who have assumed liability for A and/or B, so that it is always clear who, other than T, “holds the bag”, so-to-speak, if a valid signature is disputed. When A and/or B are not directly known to T, the three-party signing protocol becomes a legal digital covenant binding T and the parties vouching for A and/or B, rather than one directly binding A, B, and T.

The reader will further appreciate that although the present invention has been described in terms of the RSA public key algorithm, the actual signing algorithm (i.e., the cryptographic algorithm used for generating digital signatures) could be any widely deployed digital signature algorithm, including the Digital Signature Algorithm (DSA) which is part of the Digital Signature Standard (DSS) developed by the National Institute of Standards and Technology (NIST). In fact, any digital signature algorithm could be utilized with the described invention.

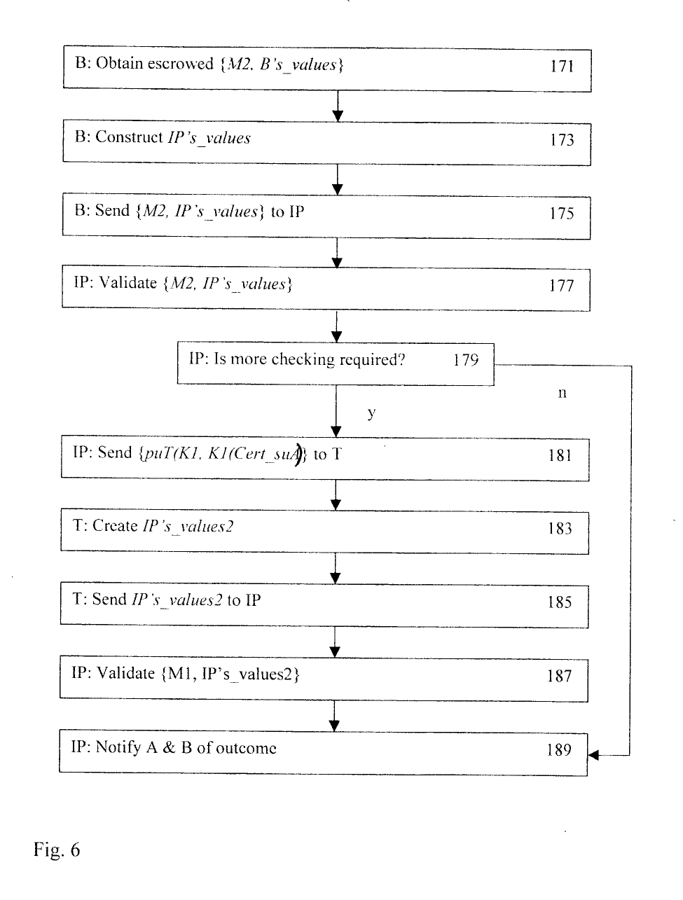

FIG. 6 is a flowchart of protocol steps for handling disputes in a three-party signing protocol, based on either the first embodiment (FIG. 2) or the second embodiment (FIG. 3) of the invention. In order to resolve a dispute, which could arise in several possible ways, we assume that B initiates the resolution protocol in response to a claim by A that it did not sign a data D, in question. An Impartial Party (IP) is used in the resolution protocol.

Receiver B obtains {M2, B's_values} corresponding to data D from its place of escrow in step 171, and it obtains whatever other information it needs in order to compute carry out the necessary steps of the resolution protocol. For example, B needs access to its private decryption key prB and to IP's certificate Cert-puIP.

Receiver B constructs IP's values in step 173 from B's_values, by performing the following steps: B's_values is parsed to obtain puB(K2), K2(D) and K2(RN). The encrypted value puB(K2) is decrypted under B's private decryption key prB to recover K2. Next, Cert-puIP is validated using the PKI. Note that Cert-puIP may be a “certificate chain” composed of several linked certificates, in which case the entire chain of certificates is validated using the PKI. Then, the recovered key K2 is encrypted with IP's public encryption key puIP, obtained from Cert-puIP. Finally, IP's_values={puIP(K2), K2(D), K2(RN)} is formed by concatenating together the values puIP(K2), K2(D), and K2(RN). Note that IP's_values is constructed from B's_values by replacing puB(K2) with puIP(K2), i.e., by replacing puB(K2) with an encrypted key that IP can decrypt and recover.

Receiver B sends {M2, IP's_values to the impartial party IP in step 175. Impartial party IP validates the received {M2, IP's_values} in step 177 by performing steps—basically a “mirror” of the steps that B originally performed to validate the received {M2, B's_values}—as follows: IP's_values is parsed to obtain puIP(K2), K2(D) and K2(RN); M2 is parsed to obtain A2, M1, sigT(Q2), and Cert-suT; M1 is parsed to obtain K1(A1), T, B, H(D,RN), sigA(Q1), puT(K1), and K1(Cert-suA). Note that although IP “sees” A's signature sigA(Q1), this does no harm, as sigA(Q1) is a randomized signature due to the random number RN concatenated with D before hashing and signing with A's private signature generation key srA. In any case, IP is a trusted party. Consistency checking is performed on A2, e.g., by verifying that A2 is the identifier of the expected sender, or that A2 is at least an identifier of a sender known to the receiver. Next, the association between T and Cert-suT is verified, e.g., to ensure that Cert-suT is a certificate belonging to the anticipated trusted third party T, or that T is at least an identifier of a trusted third party known to the receiver. Next, the received value of B is verified to be this receiver's identifier. Next, Cert-suT is validated using the PKI. Note that Cert-suT may be a “certificate chain” composed of several linked certificates, in which case the entire chain of certificates is validated using the PKI. Individual hash values are computed on A2, K1(A1), T, B, H(D,RN), sigA(Q1), puT(K1), and K1(Cert-suA) to produce H(A2), H(K1(A1)), H(T), H(B), H(H(D,RN)), H(sigA(Q1)), H(puT(K1)), and H(K1(Cert-suA))}. Then, value Q2={A2, M1, H1, . . . , H8} is formed by concatenating A2, M1, and hash values H1 through H8, and the signature sigT(Q2) generated on the formed value Q2 is verified using T's signature verification key suT obtained from Cert-suT. Next, puIP(K2) is decrypted using IP's private decryption key prIP; and K2(D) and K2(RN) are decrypted with the recovered value of K2 to obtain D and RN, respectively. In this case, the consistency checking performed on D by B need not be performed by IP. Next, the value (D,RN) is formed by concatenating the recovered values of D and RN, and the hash value H(D,RN) is computed on (D,RN) using the same one-way hash function used by sender A. Then, the computed hash value H(D,RN) is verified to be equal to the hash value H(D,RN) received in M2. If the hash values are not equal, then {M2, IP 's_values} is rejected and sender A is upheld (i.e, A wins the dispute and B loses), and no further checking is performed by IP. But, if the hash values are equal, then further checking must be performed by IP in order to determine whether A's signature is valid or not valid.

IP determines whether further checking is required in step 179. If further checking is required, IP sends {puT(K1), K1(Cert-suA)} to T in step 181 and requests T's help in resolving the dispute between A and B. Otherwise, impartial party IP contacts A and B and provides them with the outcome of the three-party signing resolution protocol in step 189.

In response, trusted third party T creates IP's_values2 in step 183 by performing the following steps: puT(K1) is decrypted with T's private decryption key prT to obtain K1. Next, Cert-puIP is validated using the PKI. Note that Cert-puIP may be a “certificate chain” composed of several linked certificates, in which case the entire chain of certificates is validated using the PKI. Then, the recovered key K1 is encrypted with IP's public encryption key puIP, obtained from Cert-puIP. Finally, IP's_values2={puIP(K1), K1(Cert-suA), Cert-puT} is formed by concatenating the values puIP(K1), K1(Cert-suA), and Cert-puB. Note that the inclusion of Cert-puT in IP's_values2 is optional, depending on (1) whether the checking performed by IP requires the use of Cert-puT, and (2) whether IP can obtain its own copy of Cert-puT if the checking performed requires Cert-puT.

Trusted third party T sends IP's values2 to the impartial party IP in step 185. Impartial party IP validates M1, which it parsed from the value M2 received from B, using the IP's_values2 received from T in step 187 by performing steps—basically a “mirror” of the steps that T originally performed to validate the received value M1—as follows: IP's retained copy of M2 is parsed to obtain A2, M1, sigT(Q2), and Cert-suT and M1 is parsed to obtain K1(A1), T, B, H(D,RN), sigA(Q1), puT(K1), and K1(Cert-suA). IP's_values2 is parsed to obtain puIP(K1), K1(Cert-suA), and Cert-puB. puIP(K1) is decrypted with IP's private decryption key prIP to recover K1; K1(Cert-suA) is decrypted with K1 to recover Cert-suA; and K1(A1) is decrypted with K1 to recover A1. Note that IP is a trusted party, and therefore, under the terms and conditions of the three-party signing protocol, is permitted to “see” Cert-suA and A1. Next, the intermediate value Q1={A1, T, B, H(D,RN)} is formed by concatenating the identifiers A1, T, and B, with the hash value H(D,RN). The association between A1 and Cert-suA is examined to verify that Cert-suA is in fact a certificate associated with identifier A1. Cert-suA is validated using the PKI (note that Cert-suA may be a “certificate chain” composed of several linked certificates, in which case the entire chain of certificates is validated using the PKI). The signature sigA(Q1) generated on Q1 is verified against the formed value of Q1 using A's signature verification key suA obtained from Cert-suA. If A's signature is valid, then B wins, T wins, and A loses. If A's signature is not valid, then B wins, A wins, and T loses.

The reader will appreciate that IP only indirectly knows that the recovered key K1, obtained by decrypting puIP(K1) with IP's private decryption key prIP, is equal to the recovered key K1 obtained by decrypting puT(K1) with T's private decryption key prT, where puT(K1) is the value obtained by parsing M1. However, since the recovered value of Cert-suA, obtained by decrypting K1(Cert-suA) with K1 is validated using the PKI, we are therefore assured that the recovered value of Cert-suA is indeed a valid certificate. For practical purposes, this is enough to ensure that the value of K1 obtained by decrypting puIP(K1) is indeed the correct key, and equal to the key in the encrypted value puT(K1), obtained by parsing M1. In addition, there is no motivation for T to send IP a false K1 that would cause IP's validation of A's signature to fail, as this would result in A winning and T losing. On the contrary, T should be motivated to do all it can to show that A's signature is valid, not invalid. Nevertheless, if the method of encryption used by T to produce puT(K1) is not a randomized encryption procedure, such that no unknown values are introduced into the encryption process except K1, then IP can perform an additional check on K1 by validating the received Cert-puT, encrypting K1 with puT obtained from Cert-puT to produce ciphertext puT(K1), and then comparing, for equality, this so-produced value with the value of puT(K1) obtained by parsing M1.

Impartial party IP notifies A and B and provides them with the outcome of the three-party signing resolution protocol in step 189. The reader will appreciate that in the three-party signing protocol it is possible for T to be left “holding the bag”, so to speak. Since it is T who vouches for A's signature to B, it is T who is held responsible in the dispute resolution phase if T's signature is found to be valid, but A's signature is not found to be valid. After all, if T wrongly vouches for A's signature, then (rightly so) T should be the party held responsible. Precisely what this implies with respect to the application utilizing the three-party signing protocol will depend on the application itself, and the terms and conditions agreed to in advance by the parties using the protocol. For example, if A defaults on a payment to B and T loses during the dispute resolution phase because T's signature is verified and A's signature is not verified, then (depending on the terms and conditions) T might be held accountable for making the payment to B. In practice, it is difficult to imagine of a set of conditions under which an honest T would ever be the party held responsible under the rules of the dispute resolution protocol (simply stated T does not sign unless it first determines A's signature is valid).

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A three-party signing method that protects the privacy of the signer and prevents verifiers from colluding to cross-link information signed by the signer, the method comprising the steps of:
generating by a signer A a signature S1 on a representation of at least data D;
sending by A the representation of at least the data D with the signature S1 to a trusted third party T;
verifying by T the signature S1 on the representation of at least data D, and if the signature S1 on the representation of at least data D is valid, then generating by T a signature S2 on the representation of at least data D;
sending by T a representation of signature S1 together with the representation of at least data D and the signature S2 to an intended receiver B, or else sending by T a representation of signature S1 together with the representation of at least data D and the signature S2 to A, who in turn sends the representation of signature S1 totether with the representation of at least data D and the signature S2 to B, whereby the representation of signature S1 is such that it cannot be used by B to cross-link information signed by A; and
verifying by B the signature S2, and if the signature S2 on the representation of at least the data D is valid, then
escrowing by B at least a copy of the representation of at least the data D, the representation of signature S1, and the signature S2 in case a dispute arises in which B must later prove to an impartial party that A indeed signed the representation of at least the data D, whereby B is assured that A's signature S1 generated on the representation of at least data D was also valid, in which case B can trust that A did indeed sign the representation of at least data D, even though B does not verify A's signature S1 directly.

2. The three-party signing method of claim 1, wherein the signature S1 is selected from the group consisting of a non-randomized signature and a randomized signature.

3. The three-party signing method of claim 2, wherein the signature S1 is a non-randomized signature.

4. The three-party signing method of claim 2, wherein the signature S1 is a randomized signature.

5. The three-party signing method of claim 4, wherein said randomized signature S1 has a property of appearing to be randomly generated.

6. The three-party signing method of claim 5, wherein said randomized signature S1 is generated by a signature algorithm that automatically produces randomized signatures.

7. The three-party signing method of claim 4, wherein said randomized signature S1 has a property of appearing to be randomly generated even when a same key is used repeatedly to sign the same data.

8. The three-party signing method of claim 4, wherein said randomized signature S1 is generated by the step of padding at least the data D with a random pad value R prior to generating the signature S1 on at least the data D, further comprising the steps of:
sending by A the random pad value R along with the at least the data D (D, R) to T; and
sending by T the random pad value R along with the at least the data D (D, R) to B, or else sending by T the random pad value R along with the at least the data D (D, R) to A, who in turn sends the random pad value R along with the at least the data D (D, R) to B.

9. The three-party signing method of claim 1, wherein the representation of signature S1 is selected from the group consisting of an encryption of A's non-randomized signature and A's randomized signature.

10. The three-party signing method of claim 9, wherein said representation of signature S1 is an encryption of A's non-randomized signature, further comprising the step of encrypting by T S1 under a key that will permit T to later decrypt and recover it, the encrypted signature S1 being sent to B by T together with the representation of at least the data D, or else the encrypted signature S1 being sent by A to T together with the representation of ast least the data D, and in turn the encrypted signature S1 being sent to B by A together with the representation of at least the data D.

11. The three-party signing method of claim 10, wherein the step of encrypting signature S1 is performed with a public/private key encryption method.

12. The three-party signing method of claim 1, wherein the step of generating by T a signature S2 on the representation of at least data D is performed with a public/private key signature method.

13. The three-party signing method of claim 12, wherein T uses a single public/private key pair for all different A and B pairs.

14. The three-party signing method of claim 13, wherein pseudonymous identifiers A1, A2, . . . , An are used to distinguish one A from another A and wherein the pseudonymous identifiers are different from the public key of the public/private key pair.

15. The three-party signing method of claim 1, wherein to preclude possible protocol difficulties or abuses, wherein B inadvertently or purposely loses the representation of signature S1, thereby preventing T from proving to an impartial party that A signed data in question, further comprising the step of signing by T both the representation of at least the data D and the signature S1 so that T is assured that B must make the representation of the signature S1 available to an impartial party who is asked to verify S2.

16. The three-party signing method of claim 1, wherein the representation of at least the data D is selected from the group consisting of at least the data and a hash value computed on at least the data.

17. The three-party signing method of claim 16, wherein the representation of at least the data D is at least the data.

18. The three-party signing method of claim 16, wherein the representation of at least the data D is a hash value computed on the at least the data.

19. The three-party signing method of claim 1, wherein the step of verifying by B includes the step of validating a received representation of at least data D against an available copy of the data D.

20. The three-party signing method of claim 19, wherein B generates the data D which is sent to A and use by A to generate a signature S1 on a representation of at least data D.

21. The three-party signing method of claim 19, wherein A generates the data D, used by A to generate a signature S1 on a representation of at least data D, and provides a copy of the data D to B.

22. The three-party signing method of claim 19, further comprising the steps of:
padding by A at least the data D with a random pad value R prior to generating the signature S1 on at least the data D;
computing by A a hash value H(D, R) on a concatenation of at least the data D and the random pad value R;
sending by A the computed hash value H(D, R) with the representation of the signature S1 and the random pad value R along with the representation of at least the data D to T which, if verified by T, sends the computed hash value H(D, R) to B, or T sends the compute has value H(D, R) to A who in turn sends the computed hash value H(D, R) to B;
sending by A an encrypted (D, R) to B;
decrypting by B the received encrypted (D, R);
computing by B the hash value of the decryption of the encrypted (D, R) received from A; and
comparing by B the hash value of (D, R) computed by B with the hash value received by B from T, or from A.

23. A three-party signing method that protects the privacy of the signer and prevents verifiers from colluding to cross-link information signed by the signer, the method comprising the steps of:
generating by a sender A a value M1 containing information identifying the sender A to a trusted third party T, information identifying an intended receiver B to the trusted third party T, information specifying data D, a signature S1 on at least a sub-portion of M1 containing at least the information specifying the data D;
sending by A the value M1 containing the information specifying the data D with the signature S1 to the trusted third party T;
validating by T the value M1, and if the value M1 is validated, then generating by T a psuedonymous identifier A1 for the sender A and a value M2 containing psuedonymous identifier A1 permitting A's psuedonymous identity to be determined by the receiver B, a copy of the information specifying the data D, a copy of A's signature S1 encrypted in a key that will allow only the trusted third party T to decrypt and recover it, a copy of T's signature S2 on at least a sub-portion of the value M2 containing at least a copy of the information specifying the data D that sender A provided to trusted third party T in value M1;
sending by T the value M2 to the A, who in turn sends M2 to the intended receiver B, or else sending by T the value M2 directly to B; and
validating by B the value M2, and if the value M2 is valid, then B is assured that A's signature S1 generated on data D was also valid, in which case B can trust that A did indeed sign D, even though B does not verify A's signature directly, or even “see” A's signature.

24. The three-party signing method of claim 23, wherein A's signature S1 is encrypted using a public key cryptographic method.

25. A three-party signing method that protects the privacy of the signer and prevents verifiers from colluding to cross-link information signed by the signer, the method comprising the steps of:
creating and transmitting protocol information between a sender A, a trusted third party T and an intended receiver B, which includes generating and verifying of digital signatures S1 for the sender A and S2 for the trusted third party T in a manner that prevents the signature S1 from being cross-linked to data signed by the sender A;
escrowing the protocol information; and
resolving disputes between the sender A and the receiver B using an impartial party IP which accesses the escrowed protocol information.

26. The three party signing method of claim 25, wherein the step of resolving disputes between the sender A and the receiver B using an impartial party IP comprises the steps of:
initiating by the receiver B a resolution protocol in response to a claim by the sender A that it did not sign data D;
accessing by receiver B information corresponding to data D from its place of escrow needed in order to carry out necessary steps of the resolution protocol;
constructing by receiver B IP information for the impartial party IP from the information accessed from the place of escrow;
sending by receiver B the constructed IP information to the impartial party IP;
validating by the impartial party IP the IP information received from the receiver B;
determining if the IP information sent by B is valid and, if not, notifying the sender A and the receiver B that sender A wins the dispute and receiver B loses; otherwise,
determining by the impartial party IP that further checking must be performed by IP in order to determine whether A's signature is valid or not valid;
sending by the IP information to T and requesting T's help in resolving the dispute between A and B;
accessing by trusted third party T information corresponding to data D;
constructing by the trusted third party T second IP information for the impartial party IP from the information accessed by T;
sending by trusted third party T second IP information to the impartial party IP;
validating by impartial party IP the second IP information received from trusted third party T, whereby if A's signature is valid, then B wins, T wins, and A loses, but if A's signature is not valid, then B wins, A wins, and T loses; and
notifying A and B of the outcome of the validating step.

27. The three-party signing method of claim 26, wherein the data D is selected from the group consisting of the data D and a value computed as a function of the data D.
